(19) United States
(12) Patent Application Publication
(10) Pub. No.: US 2016/0281345 A1
(43) Pub. Date: Sep. 29, 2016

(54) RESILIENT SEAL

(71) Applicant: LARGE CALIBER DESIGN, LLC, CHURUBUSCO, IN (US)

(72) Inventor: MICHAEL R. MILLER, CHURUBUSCO, IN (US)

(21) Appl. No.: 15/058,679

(22) Filed: Mar. 2, 2016

Related U.S. Application Data
(60) Provisional application No. 62/128,168, filed on Mar. 4, 2015.

(51) Int. Cl. E03F 3/04; F16J 15/02; F16L 41/08

(52) U.S. Cl. CPC E03F 3/04; F16L 41/088; F16J 15/025

(57) ABSTRACT

An embodiment of the present disclosure provides a compression seal configured to be disposed about a pipe. The compression seal includes a cylindrical body made of a resilient material. The cylindrical body includes a hollow bore extending a longitudinal extent of the cylindrical body, and inner and outer surfaces. The inner cylindrical surface faces the hollow bore. The outer surface is located on the cylindrical body opposite the inner cylindrical surface. The cylindrical body also includes primary and secondary lobes. The primary and secondary lobes extend longitudinally as at least part of the outer surface of the cylindrical body. The primary lobe also has an inclined plane surface. This inclined plane surface of the primary lobe ascends in a direction away from the secondary lobe.

### RELATED APPLICATION

The present application relates to and claims priority to U.S. Provisional Patent Application Ser. No. 62/128,168, filed on Mar. 4, 2015. The subject matter disclosed in that provisional application is hereby expressly incorporated into the present application.

### TECHNICAL FIELD AND SUMMARY

The present disclosure is related to a resilient compression seal which may be used to assist sealing and flexibly connecting a pipe that is connected to an underground structure such as a cast-in or precast concrete manhole or like structure.

Sealing and flexibly connecting underground piping systems with underground structures can reduce infiltration/exfiltration of both groundwater and effluent. Flexible connections such as disclosed herein may help resolve differential loads on the pipe and manhole so that settling will not point load the pipe/structure interface. Accordingly, an illustrative embodiment of the recent disclosure provides a compression seal configured to be disposed about a pipe. The compression seal comprises a cylindrical body made of a resilient material. The cylindrical body includes a hollow bore extending a longitudinal extent of the cylindrical body, and an outer surface, and an inner cylindrical surface. The inner cylindrical surface faces and defines the hollow bore. The outer surface is located on the cylindrical body opposite the inner cylindrical surface. The cylindrical body comprises a primary lobe, a secondary lobe, and an anchoring lobe located between primary and secondary lobes. The primary and secondary lobes, and the anchoring lobe extend longitudinally as at least part of the outer surface of the cylindrical body and substantially tangential to the longitudinal extent of the cylindrical body. The primary lobe has an inclined plane surface that ascends in a direction away from the anchoring lobe. A bendable portion of the cylindrical body is located between the anchoring lobe and the primarily lobe. The primary lobe is foldable with respect to the cylindrical body at the bendable portion in a direction toward the hollow bore, the inner cylindrical surface, and the secondary lobe. It is appreciated that embodiments of the compression seal may provide advantages including but not limited to a broad range of sealing, employs only simple tooling (casting mandrels) for installation, may be used in both round and straight-wall structures, and one iteration may also be used as a flexible waterstop.

In the above and other illustrative embodiments, the compression seal may further comprise: the primary lobe being bendable into the hollow bore to reduce the diameter of the hollow bore to provide additional compressive material during engagement with the pipe; the secondary lobe including a protrusion depending from the inner cylindrical surface of the cylindrical body, and wherein the protrusion being configured to engage a portion of the primary flange when folded into the hollow bore of the cylindrical body; the cylindrical body being made of rubber; the primary lobe including at least one cavity being deformable under pressure; the cylindrical body being configured to receive a retaining band between the anchoring lobe and the primary lobe, and wherein the retaining band being configured to encircle the compression seal; the secondary lobe having an inclined plane surface that ascends in a direction away from the anchoring lobe; the cylindrical body includes an adhesive on the inner cylindrical surface being engagable with the primary lobe; a wedge structure being selectively engagable to both the inner cylindrical surface of the cylindrical body and the primary lobe bended into the hollow bore to form a conically shaped opening that reduces the diameter of the hollow bore to a greater extent than when not using the wedge; and the inner cylindrical surface further including a notch located adjacent the primary lobe and the anchoring lobe.

Another illustrative embodiment of the present disclosure provides a compression seal configured to be disposed about a pipe. The compression seal comprises a cylindrical body made of a resilient material. The cylindrical body includes a hollow bore extending a longitudinal extent of the cylindrical body. The cylindrical body includes inner and outer surfaces. The inner cylindrical surface faces and defines the hollow bore. The outer surface is located on the cylindrical body opposite the inner cylindrical surface. The cylindrical body also includes primary and secondary lobes. The primary and secondary lobes extend longitudinally as at least part of the outer surface of the cylindrical body. The primary lobe also has an inclined plane surface. This inclined plane surface of the primary lobe ascends in a direction away from the secondary lobe.

In the above and other illustrative embodiments, the compression seal may further comprise: the secondary lobe including an inclined plane surface that ascends in a direction away from the primary lobe; the hollow bore of the cylindrical body being configured to receive a pipe; the inner cylindrical surface being located opposite the primary and secondary lobes; wherein primary and secondary lobes are configured to be supported by the pipe extended through the hollow bore; a bendable portion of the cylindrical body located adjacent the primary lobe; the primary lobe being foldable with respect to the cylindrical body at the bendable portion in a direction toward the hollow bore, the inner cylindrical surface, and the secondary lobe; the primary lobe is also bendable into the hollow bore to form a conically shaped opening that reduces the diameter of the hollow bore to provide additional compressive material during engagement with the pipe; the secondary lobe includes a protrusion depending from the inner cylindrical surface of the cylindrical body; the protrusion being configured to engage a portion of the primary flange when folded into the hollow bore of the cylindrical body; and the primary lobe including at least one cavity that is deformable under pressure.

Another illustrative embodiment of the present disclosure includes methods for making a manhole or methods for installing a pipe in a manhole. An illustrative embodiment of such methods may include providing a compression seal that includes a cylindrical body made of a resilient material, wherein the cylindrical body includes a hollow bore extending a longitudinal extent of the cylindrical body; wherein the cylindrical body includes an outer surface and an inner cylindrical surface, wherein the inner cylindrical surface faces and defines the hollow bore and the outer surface is located on the cylindrical body opposite the inner cylindrical surface, wherein the cylindrical body comprises a primary lobe and a secondary lobe located opposite the secondary lobes, wherein the primary and secondary lobes extend longitudinally as at least part of the outer surface of the cylindrical body and substantially tangential to the longitudinal extent of the cylindrical body, wherein the primary lobe has an inclined plane surface, wherein the inclined plane surface of the primary lobe ascends in a direction away from the secondary lobe, and a bendable portion of the cylindrical body adjacent the primarily lobe; providing a casting mandrel and inner and outer form walls; placing the inner form wall spaced apart and facing the outer form wall to create at least a portion of a manhole shape; disposing the casting mandrel through the hollow bore of the compression seal placing the casting mandrel and compression seal between the inner and outer form walls; filling space between the form walls and around the compression seal with concrete such that the concrete forms at least a portion of the manhole; removing the inner and outer form walls and the mandrel from the concrete after the concrete has solidified, wherein the removing the casting mandrel leaves an opening in the manhole with the inner cylindrical surface of the compression seal forming a periphery of at least a portion the opening of the manhole; and folding the primary lobe of the compression seal at the bendable portion over in the opening of the manhole toward the secondary lobe of the compression seal reducing the opening's diameter when the primary lobe is folded over toward the secondary lobe. The method for installing the pipe in the manhole may further comprise the steps of inserting a pipe into the opening of the manhole engaging a seal between the pipe and the primary lobe of the compression seal.

Additional features and advantages of the resilient seal assembly will become apparent to those skilled in the art upon consideration of the following detailed description of the illustrated embodiment exemplifying the best mode of carrying out the resilient seal assembly as presently perceived.

### BRIEF DESCRIPTION OF THE DRAWINGS

The present disclosure will be described hereafter with reference to the attached drawings which are given as non-limiting examples only, in which:

FIG. 1 is a perspective view of an embodiment of a seal according to an illustrative embodiment of the present disclosure;

FIG. 2 is a cross-sectional view of the asymmetrical compression seal of FIG. 1;

FIG. 3 is a side-sectional detail view showing the asymmetrical compression seal of FIG. 1 in a use condition attached to a manhole and a pipe engaging the seal;

FIG. 4 is a sectional exploded view of a resilient seal assembly components including inner and outer form walls and casting mandrel to cast the shape of the manhole, the compression seal, and a resilient filler material body;

FIG. 5 is a side cross-sectional view of the resilient seal assembly in use as part of the concrete manhole;

FIG. 6 is a side cross-sectional view of the manhole with the form walls and casting mandrel removed, but the compression seal and filler material body formed in the concrete manhole;

FIG. 7 is a cross-sectional view similar to FIG. 6 with the compression seal folded into a pipe insertion position as shown;

FIG. 8 is a side cross-sectional view of the manhole similar to FIG. 7 with the compression seal folded and the pipe entering the manhole opening;

FIG. 9 is a side cross-sectional view similar to FIGS. 6 through 8 showing the pipe entering the opening in the manhole and engaging the compression seal;

FIG. 10 is a side cross-sectional view of the manhole similar to FIGS. 6 through 9 depicting the pipe fully inserted therein;

FIGS. 11A through 11H are side, cross-sectional detail views of the compression seal showing illustrative configurations of the seal's lobe;

FIGS. 12A through 12C are side cross-sectional views of the compression seal showing its use with a wedge;

FIG. 13 is a cross-sectional view of another illustrative embodiment of a compression seal;

FIG. 14 is a sectional exploded view of a resilient seal assembly components including inner and outer form walls and casting mandrel to cast the shape of the manhole, the compression seal, and a resilient filler material body;

FIG. 15 is a side cross-sectional view of the resilient seal assembly in use as part of the concrete manhole;

FIG. 16 is a side cross-sectional view of the manhole with the form walls and casting mandrel removed, but the compression seal and filler material body formed in the concrete manhole;

FIG. 17 is a cross-sectional view similar to FIG. 6 with the compression seal folded into a pipe insertion position as shown;

FIG. 18 is a side cross-sectional view of the manhole similar to FIG. 7 with the compression seal folded and the pipe entering the manhole opening;

FIG. 19 is a side cross-sectional view similar to FIGS. 6 through 8 showing the pipe entering the opening in the manhole and engaging the compression seal;

FIG. 20 is a side cross-sectional view of the manhole similar to FIGS. 6 through 9 depicting the pipe fully inserted therein;

FIGS. 21A through 21H are side, cross-sectional detail views of the compression seal showing illustrative configurations of the seal's lobe;

FIGS. 22A through 22C are side cross-sectional views of the compression seal showing its use with a wedge;

FIG. 23 is a side-sectional view similar to the view shown in FIG. 5 but with another illustrative embodiment of a compression seal;

FIG. 24 is a side cross-sectional view similar to that of FIG. 23 but with the form walls and casting mandrel removed;

FIG. 25 is a side cross-sectional view similar to FIG. 24 taken along line A-A of FIG. 26 with the compression seal folder into pipe insertion position;

FIG. 26 is a front view of a portion of a manhole and opening therein with the compression seal installed and folded into pipe insertion position;

FIG. 27 is a side cross-sectional view similar to that shown in FIG. 25 but with a pipe inserted therein;

FIG. 28 is a side cross-sectional view of a portion of a manhole and opening with a compression seal folding onto a wedge;

FIG. 29 is a side partial detail view of a portion of a pipe with a compression seal attached thereto;

FIG. 30 is a side partial cross-sectional view of the pipe and compression seal of FIG. 29 fitted in a manhole opening;

FIG. 31 is a side partial sectional view of the compression seal and pipe fitted in the opening of the manhole of FIG. 30 with mortar filled between the compression seal and the periphery of the opening;

FIG. 32 is a side partial cross section detail view of a portion of the area of the pipe of FIGS. 30 through 31 demonstrating a range of motion of the pipe in relation to the compression seal;

FIG. 33 is a side partial cross-sectional view with the pipe and compression seal of FIG. 29 but with form walls and a fill material set therein prior to casting of the manhole;

FIG. 34 is a view similar to that of FIG. 33 but with the concrete poured in to form the manhole;

FIG. 35 is a view similar to that of FIG. 34 but with the forms and fill material removed;

FIG. 36 is a view similar to that of FIG. 35 but with the pipe pivoted to demonstrate a range of motion of the pipe within the manhole while still being sealed by the compression seal;

FIGS. 37A, 37B through 37C show side perspective cross-sectional views of the compression seal, manhole and pipe;

FIGS. 38A, 38B through 38C show views similar to that of FIGS. 38A through 38C with the exception of the cross-sectional portion of the views;

FIGS. 39A, 39B through 39C are full perspective views of the seal, pipe, and portion of the manhole with an opening;

FIGS. 40A and 40B are side cross-sectional views of the compression seal showing its use with a wedge;

FIG. 41 is a cross-sectional view of another illustrative embodiment of a compression seal;

FIG. 42 is an exploded view of components of a resilient seal assembly in a manhole showing the seal assembly with the compression seal, resilient gaskets, and stainless band clamps, as well as a portion of a manhole including its opening and the pipe;

FIG. 43 is a side cross-sectional view similar to FIG. 42 showing the seal assembly attached to the periphery of the pipe prior to an insertion into the manhole opening;

FIG. 44 is a view similar to FIG. 43 but showing the pipe and compression seal assembly fitted in the opening of the manhole portion;

FIG. 45 is a view similar to that of FIG. 44 but with mortar filled in between the pipe and the periphery of the opening of the manhole;

FIG. 46 is a view similar to that shown in FIG. 45 except demonstrating a range of motion of the pipe that can be made while still providing a seal;

FIGS. 47A through 47H are side cross-sectional detail views of the compression seal of FIG. 41 showing illustrative configurations of the seal's lobe;

FIGS. 48A and 48B are side cross-sectional views of the compression seal of FIG. 41 showing its use with a wedge;

FIG. 49 is a top detail view showing a portion of the curved wall of an illustrative manhole with a compression seal inserted straight in an opening;

FIG. 50 is another top view showing a portion of a curved wall of the manhole with a compression seal inserted into an opening following a curved opening;

FIG. 51 is a cross-sectional view of another illustrative embodiment of a compression seal;

FIG. 52 is another cross-sectional view of the compression seal of FIG. 51 with its lobe located in a folded position;

FIG. 53 is a cross-sectional exploded view of the compression seal of FIGS. 51 and 52 in combination with the manhole components including the inner and outer form walls, casting mandrel, and resilient filler material body;

FIG. 54 is a perspective view of a cylindrical manhole or similar water works-type structure with a pipe set to be inserted therein and employing the compression seal;

FIG. 55 is another perspective cross-sectional view of the manhole or other water works-type structure having a pipe being inserted therein;

FIG. 56 is a side cross-sectional detail view of a manhole or other water works-type structure with a pipe set to be disposed therein and employing an embodiment of the compression seal;

FIG. 57 is a side cross-sectional detail view of a manhole or other water works-type structure with a pipe set to be disposed therein and employing another embodiment of the compression seal;

FIG. 58 is a side cross-sectional detail view of a manhole or other water works-type structure with a pipe set to be disposed therein and employing another embodiment of the compression seal; and

FIG. 59 is a side cross-sectional view of a manhole or other water works-type structure employing another embodiment of the seal that is mortared into an opening in the structure.

Corresponding reference characters indicate corresponding parts throughout the several views. The exemplification set out herein illustrates embodiments of the resilient compression seal, and such exemplification is not to be construed as limiting the scope of the resilient compression seal in any manner.

### DETAILED DESCRIPTION

The present disclosure provides a new resilient or compression seal that may be placed into a pre-cast or cast-in manhole. The seal is located at the periphery of an opening of the manhole configured to receive the pipe. An illustrative embodiment includes a seal configured having a cylindrical opening that receives the pipe. This connection forms a seal between the pipe and the opening in the manhole's side wall. The cross section of the resilient seal includes an outwardly extending anchoring lobe and an angled lobe extending from at least one side, and in other embodiments both sides of the anchoring lobe. The anchoring lobe is configured to serve as a securement in the cast concrete manhole at the periphery of the manhole opening. Each of the lobes extend opposite from each other. Both lobes form a generally coplanar base, while some embodiments have diverging angular top surfaces. In some further embodiments one lobe is a stationary sealing lobe cast into position while the other lobe is configured to fold over and join the cast lobe after the manhole is cast, but before the pipe is inserted. The lobes, whether folded or not, may provide a compressive member forming the seal between the pipe and the opening in the manhole. Illustratively, an adhesive material may be applied to the underside base of the lobes prior to casting so that once the manhole is completed and the folding lobe is folded over, it attaches to the cast lobe to form the operational sealing gasket.

In a further embodiment, the lobes on each side of the anchoring lobe may not be folded. Instead they may be configured to accommodate optional restraining bands to hold the seal on the pipe during manhole casting. This may help to restrain the seal during this process. It is appreciated that embodiments of the compression seal may provide advantages including but not limited to a broad range of sealing, employs only simple tooling (casting mandrels) for installation, may be used in both round and straight-wall structures, and one iteration may also be used as a flexible waterstop

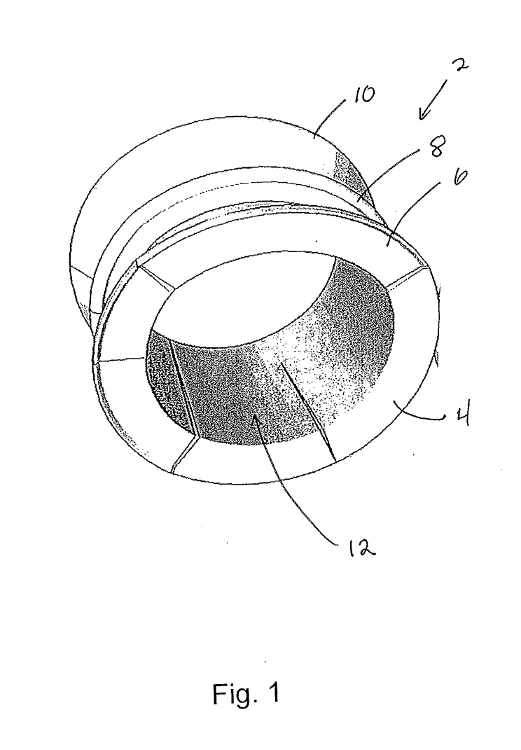

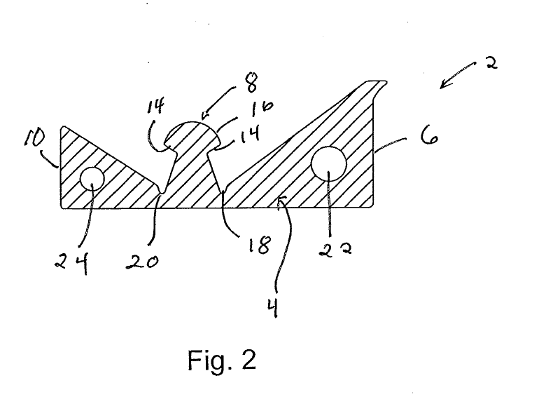

A perspective view of an illustrative embodiment of a compression seal 2 is shown in FIG. 1. This embodiment of compression seal 2 is cylindrical having a pipe opening 12 disposed through body 4, as illustratively shown. Compression seal 2 also has an asymmetrical cross-sectional profile (see, also, FIG. 2) configured to fit around a pipe and fill any space between said pipe and the pipe opening of a manhole or other like cast pipe connector. As shown in this illustrative embodiment, compression seal 2 includes a body 4 having a primary lobe 6, anchoring lobe 8, and a secondary lobe 10.

A cross-sectional view of body portion 4 of compression seal 2 is shown in FIG. 2. This view demonstrates the distinctions between primary lobe 6 and secondary lobe 10. Primary lobe 6 in this embodiment (in contrast to other embodiments) is configured to fold over and provide the primary sealing function as shown further herein, whereas secondary lobe 10 provides material support to primary lobe 6. In the illustrated embodiment, less material on secondary lobe 10 may be employed yet still perform its intended function. Also shown in this view is anchoring lobe 8 having flange 14 located about the periphery of head 16 to assist in securing compression seal 2 to the manhole, or like cast structure. Hinges 18 and 20, also shown in FIG. 2 are located on each side of anchoring lobe 8 to allow either lobe 6 or lobe 10 to pivot relative thereto. As shown, hinges 18 and 20 are indentations at the end of lobes 6 and 10, respectively. Having less material in this area increases each lobe's flexibility to hingedly move. Also shown in FIG. 2 are compression cavities 22 and 24. With compression seal illustratively made of a rubber-type or other resilient material that either compresses, shifts, or displaces like rubber, having open spaces in body 4 of lobes 6 and 10 allows said lobes to compress into these spaces. This is believed to potentially allow overall improved compression and thus sealing against a pipe as further shown herein.

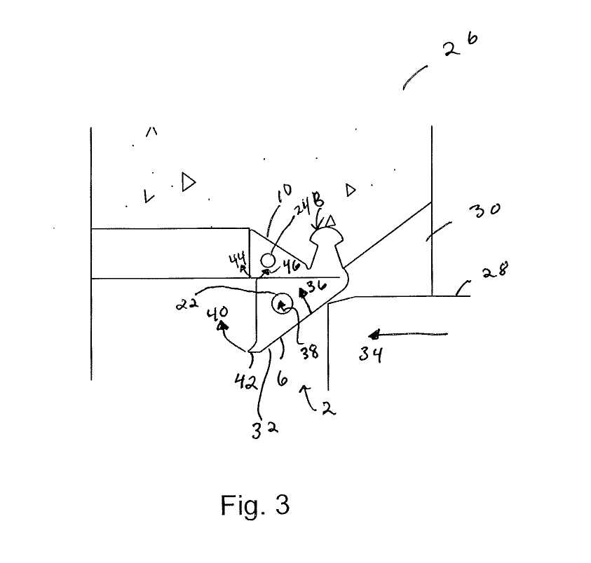

A side sectional detail view showing compression seal 2 in an operational condition in an illustrative manhole 26 with pipe 28 disposed through a pipe opening 12 is shown in FIG. 3. As depicted, compression seal 2 is secured in manhole 26 via anchoring lobe 8. Primary lobe 6 is folded over against secondary lobe 10 to provide sufficient material for pipe 28 to engage and compress against, forming sufficient sealing between pipe 28 and manhole 26. Primary lobe 6 includes an illustratively sloped surface 32 to allow pipe 28 to slide through while applying increased compression forces against pipe 28. To that end, this view depicts illustrative forces believed to help create this sealing affect. For example, as pipe 28 moves in direction 34, primary lobe 6 rotates and stretches to the extent it is folded over to secondary body 10 as shown. Alternatively, lobe 6 may be folded to the position shown prior to inserting pipe 28. Forces illustratively applied in directions 36, 38 and 40 causes lobe 6 to stretch and deform. Cavity 22 may also at least partially collapse. Tip 42 of primary lobe 6 stretches and rotates with it and surface 32 creates an active seal under pressure between secondary lobe 10, anchoring lobe 8, and pipe 28. Continued rotation of tip 42 in direction 40 along with the rest of the body causes forces against secondary lobe 10 in directions 44 and 46 which may also at least partially collapse cavity 24. With this happening around the periphery of pipe 28, no water is able to leak through from the interior side to the exterior side of manhole 26.

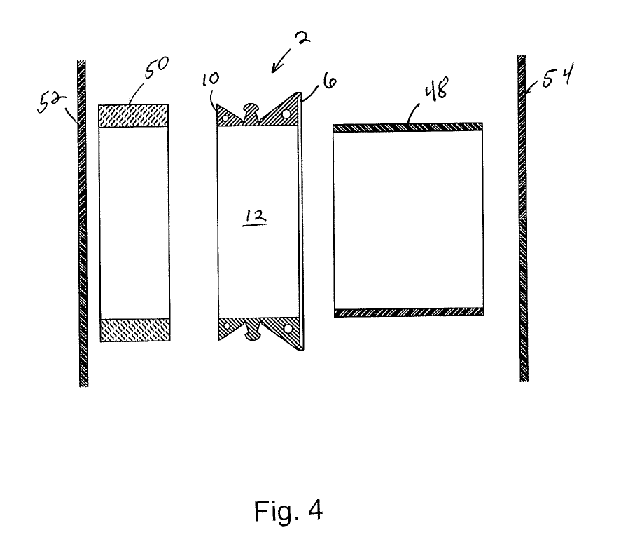

A cross-sectional exploded view of compression seal 2 along with casting components to create a manhole or other like structure that may incorporate compression seal 2, is shown in FIG. 4. Particularly, the assembly includes a casting mandrel 48, resilient filler material 50, and inner and outer form walls 52 and 54. It is appreciated that these components may vary depending on the type of manhole or other concrete or like casted structure to be created. Consequently, compression seal 2 may be conveniently cast into the structure using just the components shown. Casting mandrel 48 provides the manhole opening's shape, as well as provides a support structure for compression seal 2 during casting. Filler material 50 may also be supported by casting mandrel 48 to provide material at the periphery of the manhole opening that compression seal 2 does not occupy. Similarly, inner and outer form walls 52 and 54 create the mold providing the shape of the cast manhole.

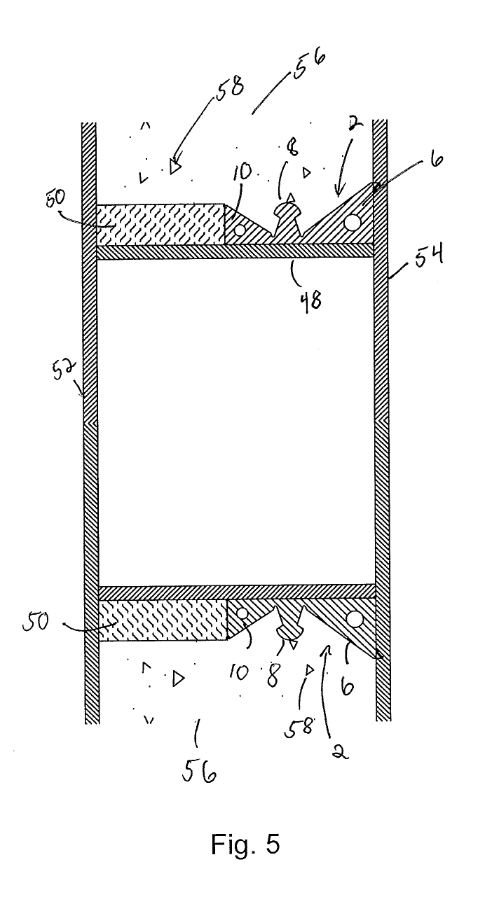

A side cross-sectional view of resilient assembly 2 being molded in manhole 26 is shown in FIG. 5. This view depicts the casting components shown in FIG. 4 assembled, just now filled with concrete 58 forming manhole 26 with compression seal 2 cast therein. As shown, compression seal 2 is fitted about the periphery of mandrel 48 along with filler material 50. These are all bounded by inner and outer form walls 52 and 54. With compression seal 2 cast therein, concrete 58 is allowed to dry at which point casting mandrel 48 and walls 52 and 54 may then be removed.

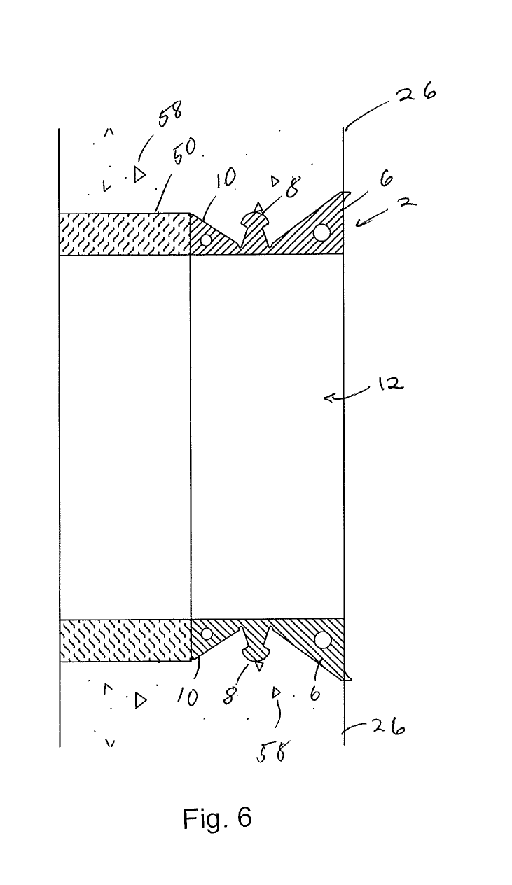

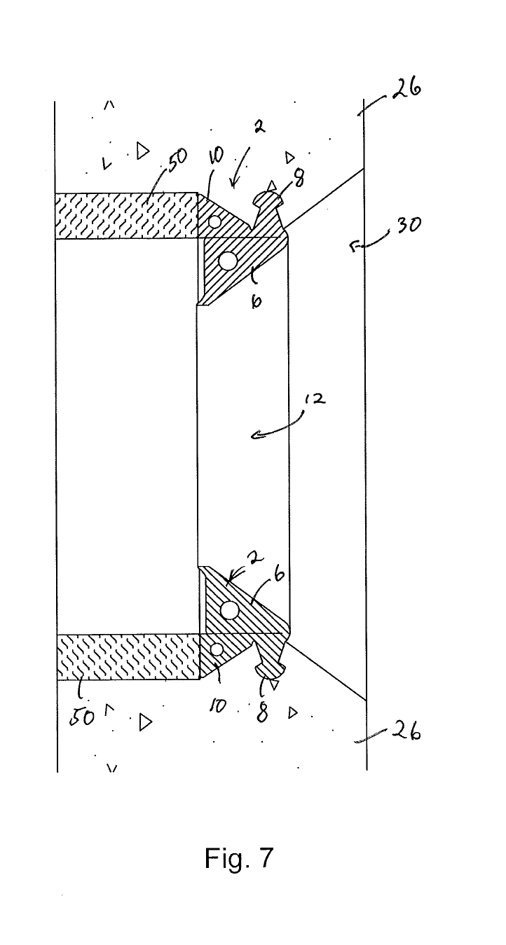

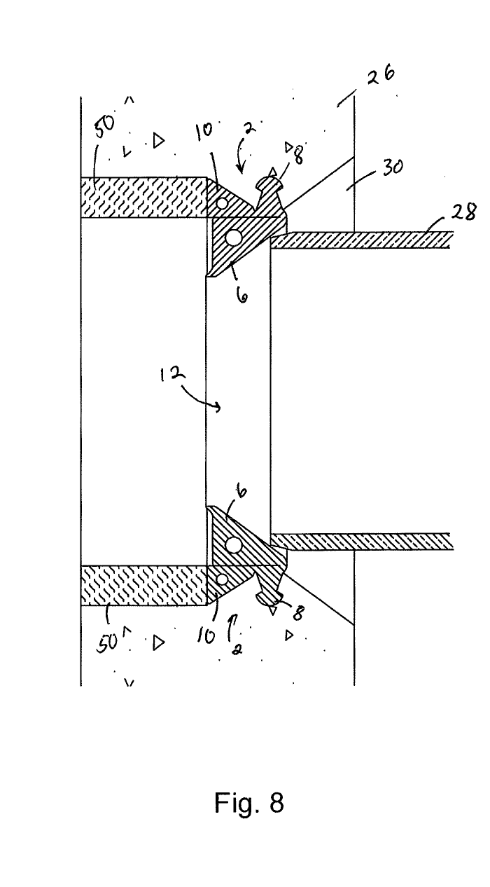

A side cross-sectional view of manhole 26 with form walls 52 and 54, and mandrel 48 all removed. In this state, manhole 26 is essentially completed with casting seal 2 formed about the periphery of pipe opening 12 in manhole 26. In this condition, manhole 26 is now almost in condition to receive a pipe. As shown in the cross-sectional side view of FIG. 7, similar to the view of FIG. 6, all that is further needed is for primary lobe 6 of compression seal 2 to be folded over as shown. In this state, pipe 28 is ready to be received in manhole 26. To that end, the side cross-sectional view of FIG. 8, similar to the views of FIGS. 6 and 7, depict pipe 28 extending into pipe opening 12 of manhole 26 and ready to engage lobe 6 of compression seal 2.

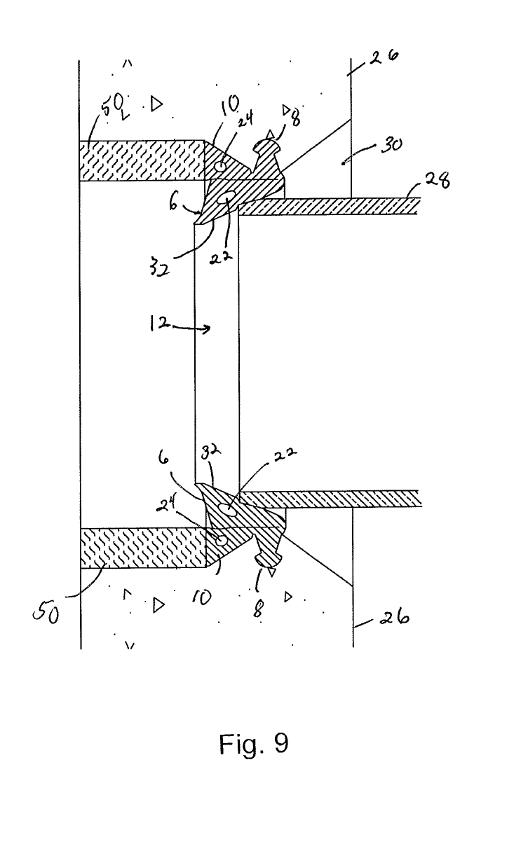

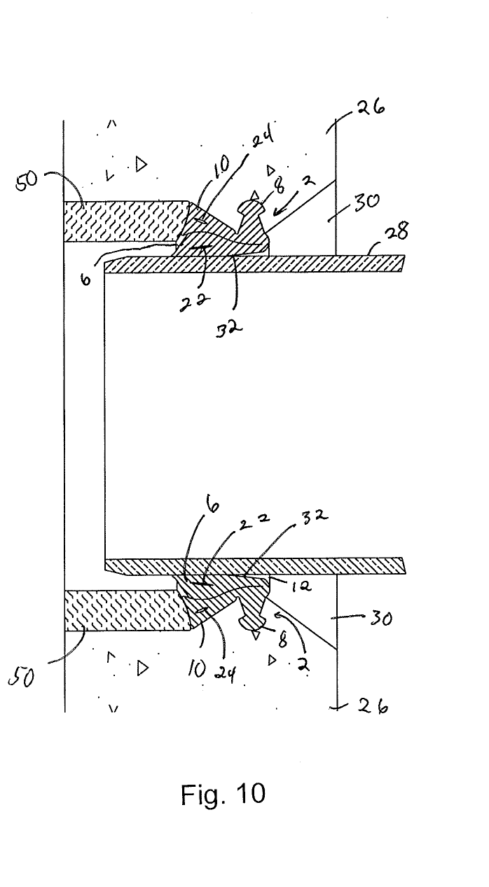

Lastly, the side cross-sectional views in FIGS. 9 and 10 depict the progression of pipe 28 engaging and then fully extending into pipe opening 12 of manhole 26, as well as opening 12 of compression seal 2. Particularly, FIG. 9 shows pipe 28 engaging surface 32 of lobe 6 deforming same. FIG. 10 shows a more substantial deformation of lobe 6 including compression of both cavities 22 and 24 of both lobes 6 and 10, respectfully. Notably, with this deformation and compression, a seal is formed between lobe 6 and the outer periphery of pipe 28. To that end, pipe 28 may be inserted as far as necessary based on need, while compression seal 2 provides the sufficient sealing that prevents any leakage from one side of manhole 26 to the other. This embodiment employs rotation and elongation of the lobe and collapse of the cavities in the lobes to create a sealing force over a range of pipe diameter angular deflections.

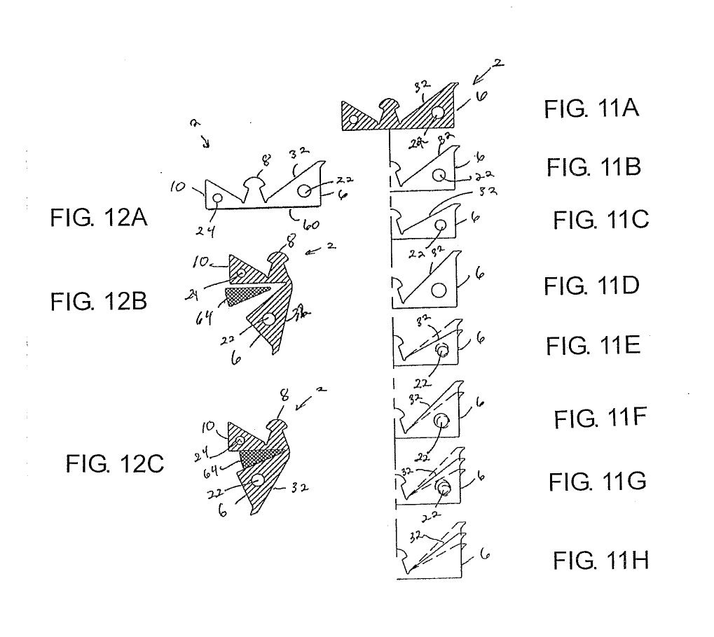

Side cross-sectional detail views of the primary lobe of compression seal 2 and its varying illustrative configurations are shown in FIGS. 11A through 11H. Particularly, the views depict how the angular deflection of lobe 6 may be changed. For example, FIGS. 11A and 11B show primary lobe 6 having a standard profile as discussed with respect to FIGS. 1 through 10. In further illustrative embodiments, the angular deflection of surface 32 of lobe 6 may be reduced as shown in FIG. 11C, or increased as shown in FIG. 11D. FIGS. 11E through 11H are detail overlay views depicting the relative deflection between the standard, increased, and decreased lobes. For example, FIG. 11D shows the relative angular difference between the standard profile (dashed lines) and the reduced deflection (overlay) of lobe 6. In contrast, FIG. 11F shows the difference between the standard profile (dashed lines) and the increased deflection (overlay) of lobe 104. FIGS. 11G and 11H show both the increased and reduced angular deflected versions overlaid on the standard profile. Additionally, cavity 22 is shown in lobe 6 of FIG. 11G, but removed in FIG. 11H.

Side cross-sectional views of compression seal 2 are shown in FIGS. 12A through 12C. As depicted in FIG. 12A, an illustrative embodiment may include an adhesive layer 60 be applied to lower surface 62 of compression seal 2. This may assist in holding primary lobe 6 against secondary lobe when folded over to hold primary lobe 6 in place before pipe 28 is inserted therein. In certain embodiments, a wedge may also be fitted between the cast and folding lobes to affect the diameter of the opening the pipe will pass through. By placing a wedge between the folded over and cast lobes, the diameter of its opening that receives the pipe is further reduced. This may be useful in circumstances where more compression is needed to make the proper seal between the pipe and the manhole, or when a pipe diameter change has been made after the manhole has either been cast or formed for cast. The views in FIGS. 12B and 12C are of compression seal 2 that employ an insert wedge 64 that may change the deflection of surface 32 of lobe 6 before pipe 28 is disposed into compression seal 2. As discussed, wedge 64 may be used to increase the compressive force that is applied to lobes 6 and 10 if necessary. Again, this may be useful in circumstances where the pipe diameter might have been unexpectedly reduced after all the dimensions of the manhole and its corresponding opening have been set. It is also appreciated that adhesive may be applied similar to that shown in FIG. 12A to secure the wedge in place prior to inserting the pipe.

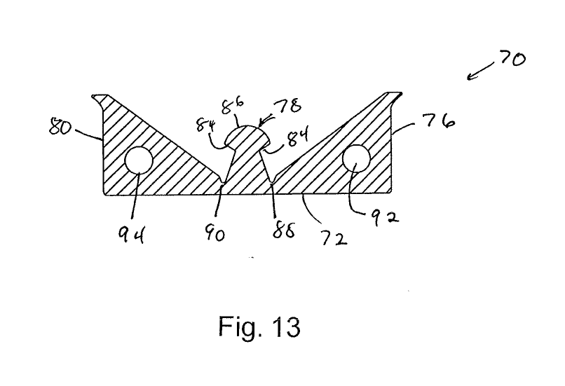

FIGS. 13 through 22 depict another illustrative embodiment of the present disclosure, similar to FIGS. 1 through 12. A compression seal 70 as illustrated in FIG. 13, includes a body 72, primary lobe 76, anchoring lobe 78, and secondary lobe 80. Flanges 84 support anchoring lobe head 86 similar to the prior embodiment. A notable difference between compression seal 70 and 2 is that lobes 76 and 80 of seal 70 are essentially symmetrical—whereas lobes 6 and 10 of seal 2 are asymmetrical.

Primary lobe 76, similar to lobe 6 in the prior embodiment, is configured to fold over to provide the primary sealing function, as shown further herein. Secondary lobe 80, also similar to secondary lobe 10 of the prior embodiment, provides material support to primary lobe 76. Anchoring lobe 78 is configured to form into the cast structure of the manhole, similar to the previous embodiment. Hinges 88 and 90 are located on each side of anchoring lobe 78 allowing either lobe 76 or 80 to pivot relative thereto. Illustratively, hinges 88 and 90 are indentations at the ends of lobes 76 and 80, respectively. As discussed with the prior embodiment, having less material in the hinge area increases the lobe's flexibility thus allowing lobe 76 and 80 to hingedly move with respect to the remainder of body 72. Also shown in this embodiment are compression cavities 92 and 94. Because this compression seal may be made of a rubber-type weather resilient material. Like compression cavities 22 and 24 compression cavities 92 and 94 are configured to compress or shift allowing portions of either lobes 76 and 80, respectively, to fill in the cavities while the compression seal 70 is being compressed.

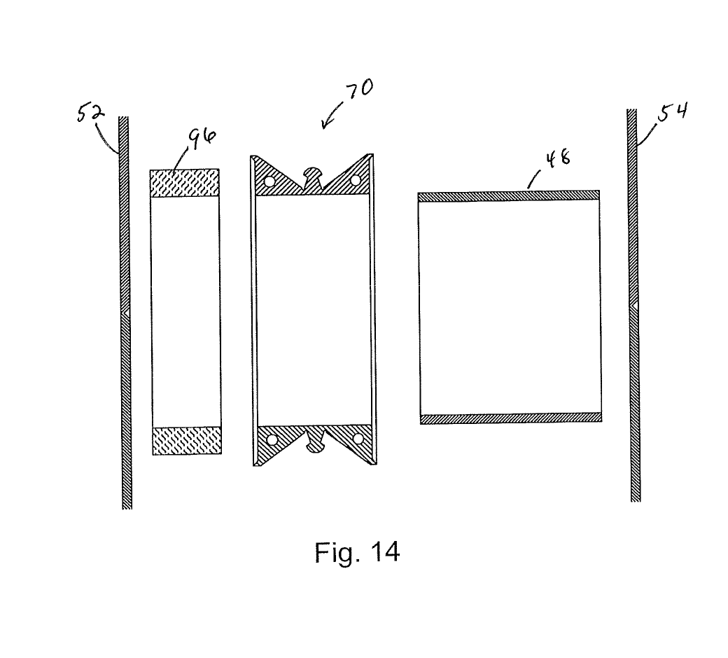

A cross-sectional exploded view of compression seal 70 along with previously described casting components to create the manhole are shown in FIG. 14. Similar to the prior embodiment, this assembly may include casting mandrel 48, resilient filler material 96, and inner and outer form walls 52 and 54. Again, casting mandrel 48 provides the manhole's opening shape, as well as provides the support structure for compression seal 70 during casting. Likewise, inner and outer form walls 52 and 54 provide the mold surfaces that create the shape of the casting manhole.

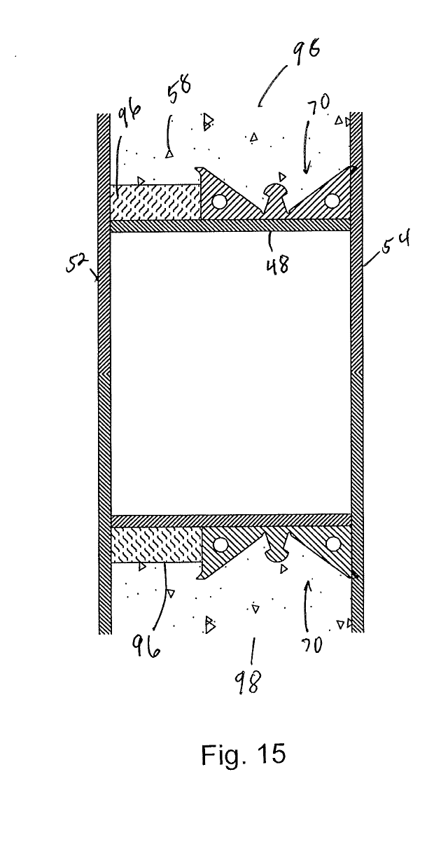

A side cross-sectional view of resilient assembly 70 being molded in manhole 98 is shown in FIG. 15. This view depicts the casting components shown in FIG. 14 still assembled but now filled with concrete 58 forming manhole 98 with compression seal 70 cast therein. Like the prior embodiment, compression seal 70 is fitted about the periphery of manhole 48. As part of the process of manufacturing manhole 98 (like manhole 26), concrete 58 is allowed to dry to hold compression seal 70 in place.

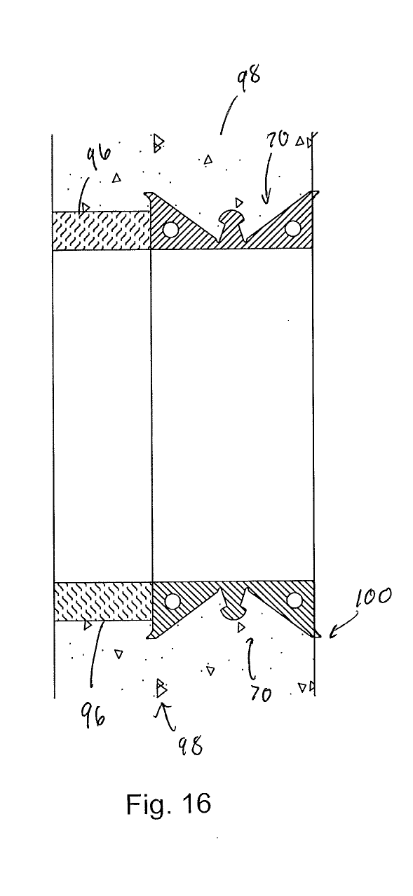

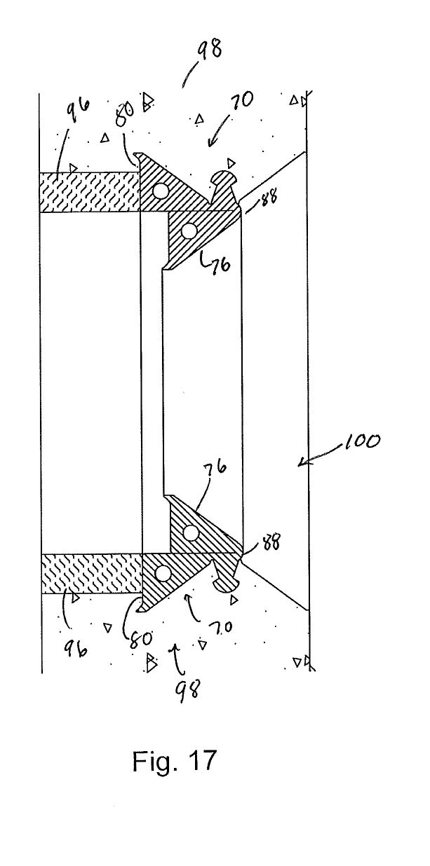

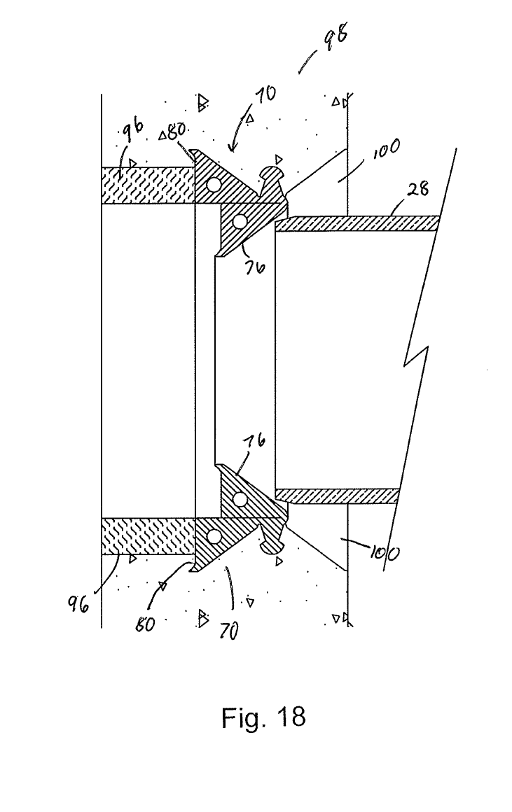

A side cross-sectional view of manhole 98 with form walls 52 and 54 and mandrel 48 all removed is shown in FIG. 16. Here, manhole 98 is fully cast with seal formed about the periphery of opening 100 in manhole 98. As shown in the cross-sectional view of FIG. 17, similar to the views in both FIGS. 15 and 16, primary lobe 76 is folded inward within opening 100 as shown. At this point, pipe 28 is ready to be received in manhole 98. A distinction that becomes clear when comparing FIG. 17 to FIG. 7 is that there is much more mold material in lobe 80 than in lobe 10 of the prior embodiment. This may provide more beneficial ceiling characteristics in the field under certain conditions. The cross-sectional view of FIG. 18, similar to the views in FIGS. 16 and 17, depict pipe 28 extending into opening 100 of manhole 98 and about to engage lobe 76 of compression seal 70.

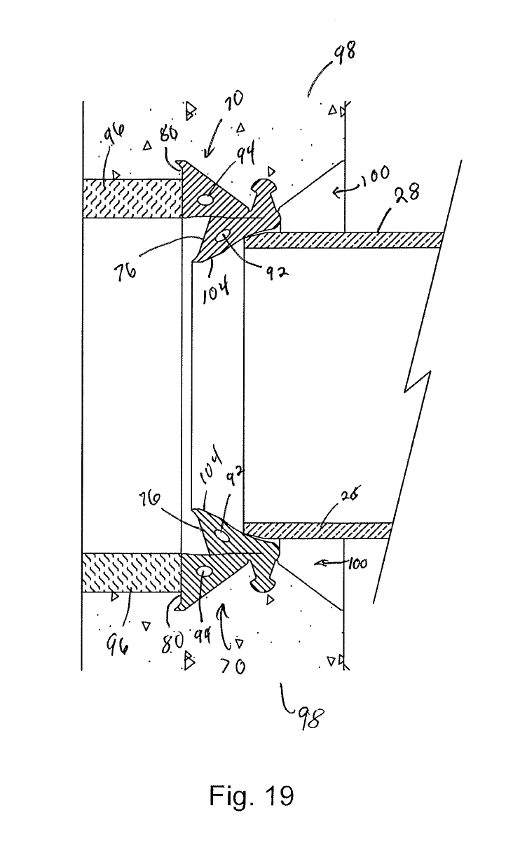

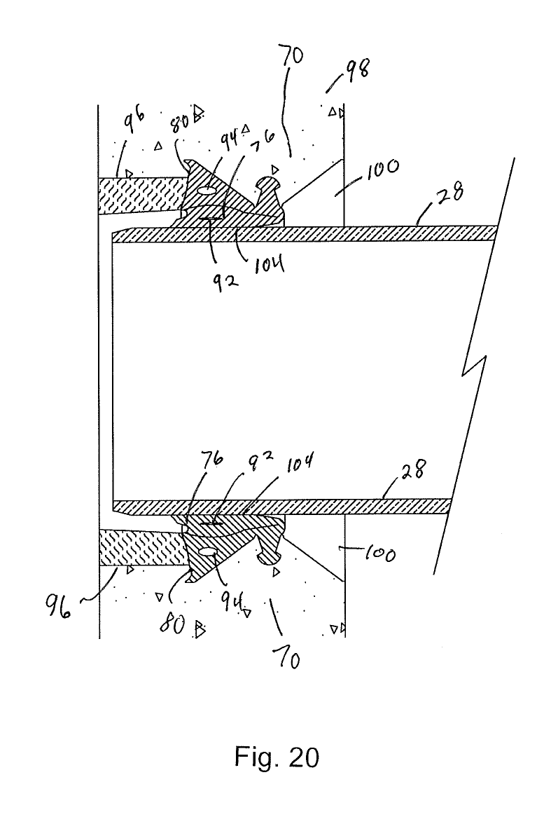

The cross-sectional views in FIGS. 19 and 20 are progression views depicted in pipe 28 engaging and then fully inserting into opening 100 of manhole 98, as well as opening 102 formed in compression seal 70. FIG. 19 shows pipe 28 engaging surface 104 of lobe 76 deforming same similar to that described with respect to compression seal 2. Further, as shown in FIG. 20, pipe 28 extends further into opening 102 and substantially deforming lobe 76, as well as a portion of lobe 80. This view also demonstrates how portions of lobe 76 and 80 fill into compression openings 92 and 94, respectively.

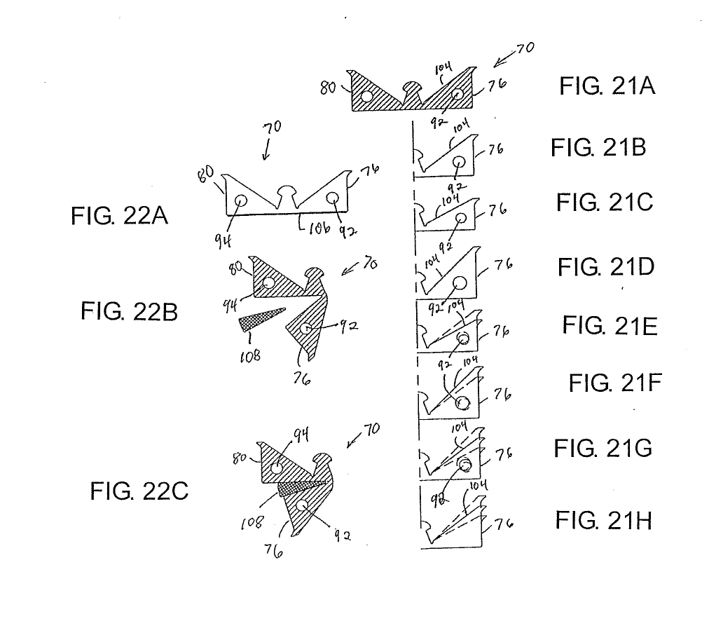

Side cross-sectional detail views of the primary lobe of compression seal 70 and its potential varying configurations are shown in FIGS. 21A and 21H. These views depict how the angular deflection of lobe 76 may be changed similar to that shown with respect to lobe 6 in FIG. 11. For instance, as shown in FIGS. 21A and 21B, primary lobe 76 is shown with its standard profile, as discussed in FIGS. 13 through 20. Additional embodiments, however, may further include lobes having a different angular deflection. As shown in FIG. 21C, surface 104 of lobe 76 may have a reduced angle, whereas surface 104 of lobe 76 shown in FIG. 21D has an increased angle. FIGS. 21D through 21H are detail overlay views that depict the relative deflection between standard, increased, and decreased lobe angles. For example, FIG. 21E depicts the relative angular difference between the standard profile (dash lines) and the reduced deflection (overlay) of lobe 104. FIG. 21F, in contrast, depicts the difference between the standard profile (dash lines) and the increase deflection (overlay) of lobe 104. Like FIGS. 11G and 11H, FIGS. 21G and 21H both show the increase and decrease angular deflection versions overlaid on the standard profile. FIG. 21G also shows the positioning of cavity 92.

Similar to the prior embodiment, the side cross-sectional views of compression seal 70, shown in FIGS. 22A, 22B, and 22C, depict the use of adhesive layer 60 being applied to the lower surface 106 of compression seal 70. As previously discussed, adhesive layer 60 may assist in holding primary lobe 76 against secondary lobe 80 before pipe 28 is inserted into compression seal 70. Also like the prior embodiment, a wedge 108 may be fitted between folded lobes 76 and secondary lobe 80. As also previously discussed, placing wedge 108 between the folded lobe 76 and 80 may change (reduce) the opening that receives the pipe. This, again, may be useful under circumstances when the diameter of the pipe extending into the manhole changes on site after the manhole has been cast.

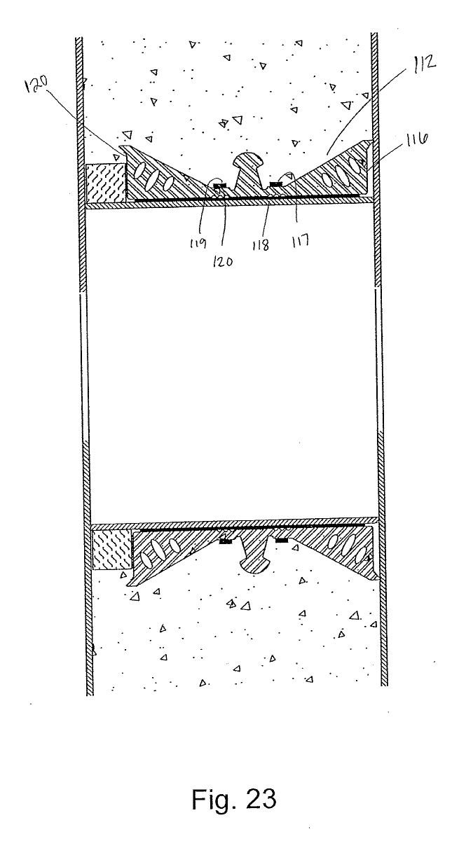

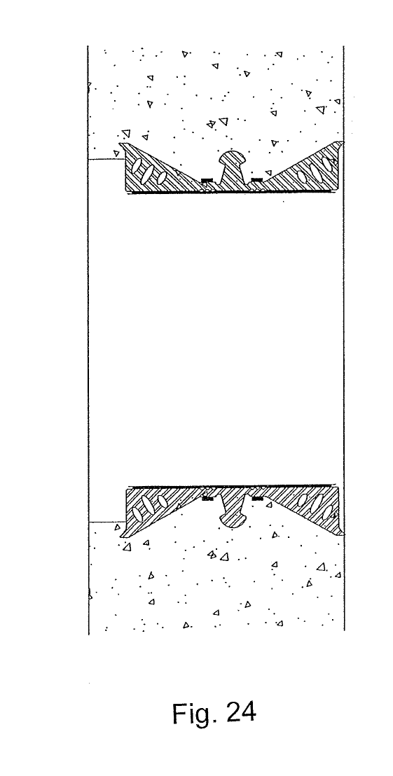

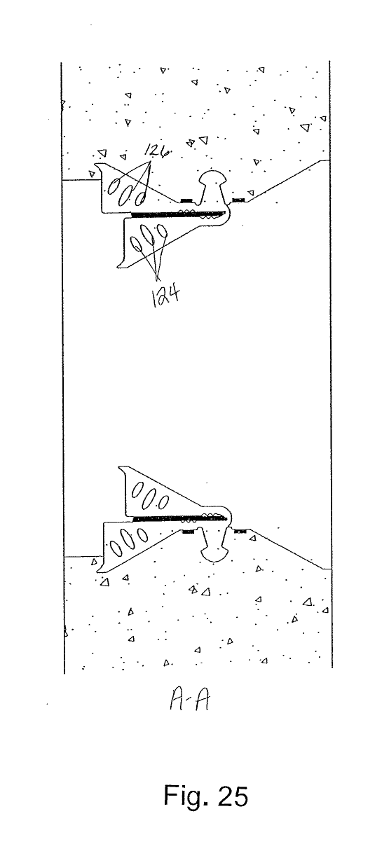

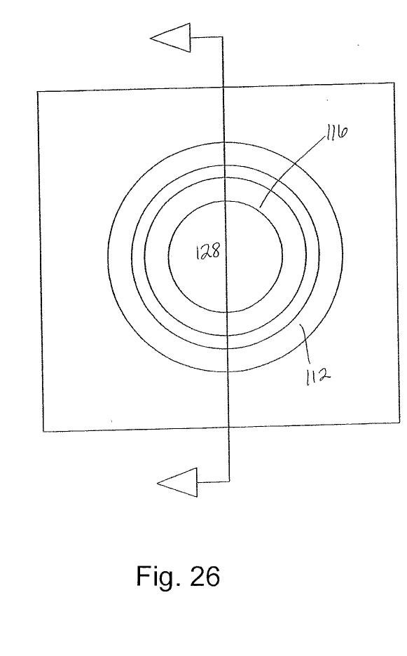

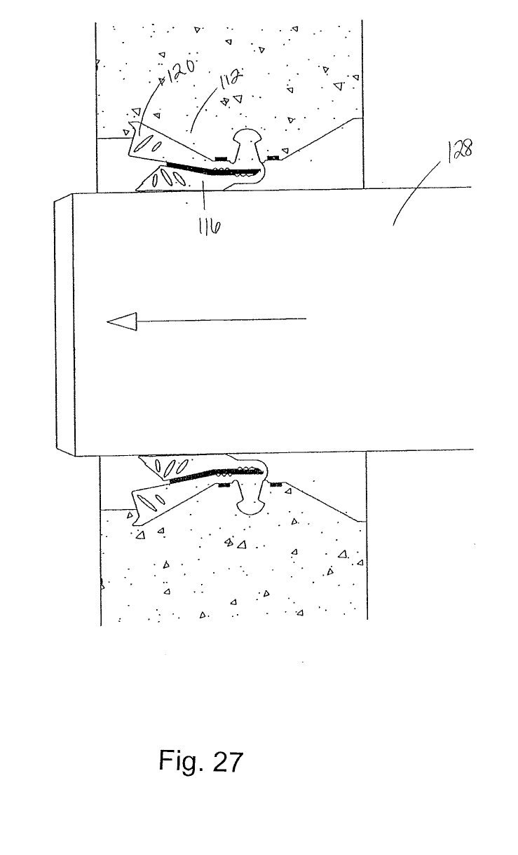

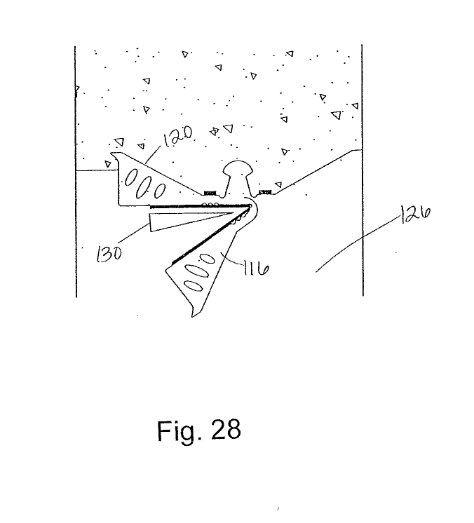

The views shown in FIGS. 23 through 28 depict another illustrative embodiment of a compression seal 112 similar to compression seal 70 except for a change in profile of lobes 116 and 120, as well as adhesive or retaining bands 117 and 119 that fit about hinge portions 118 and 122. As shown in the side cross-sectional views of FIGS. 24 and 25, the two-sided adhesive bands 117 and 119 may serve to assist positively, affixing the lobes against the manhole. The views shown in FIG. 25, taken along line A-A of FIG. 26, show views similar to FIGS. 3, 7, and 17, where lobe 116 is folded under lobe 120. It is also evident from this view the additional embodiment of cavity sets 124 and 126. As shown in this embodiment, additional cavities are available to be collapsed during insertion of a pipe into the manhole opening. The front view in FIG. 26 depicts how the periphery of opening 128 is dominated by lobe 116 of compression seal 112. Likewise, lobes 116 and 120 of compression seal 112 are compressed to form a seal against pipe 128 as it is inserted into the manhole as shown in FIG. 27. As with other embodiments, a wedge 130 may be fitted between lobes 116 and 120 to affect the diameter of opening 128 (see FIG. 26) for reasons previously described as shown in FIG. 28.

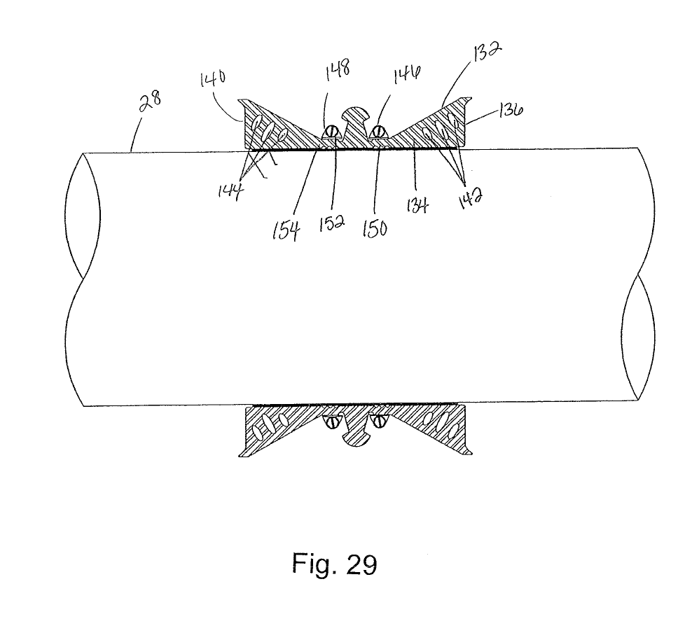

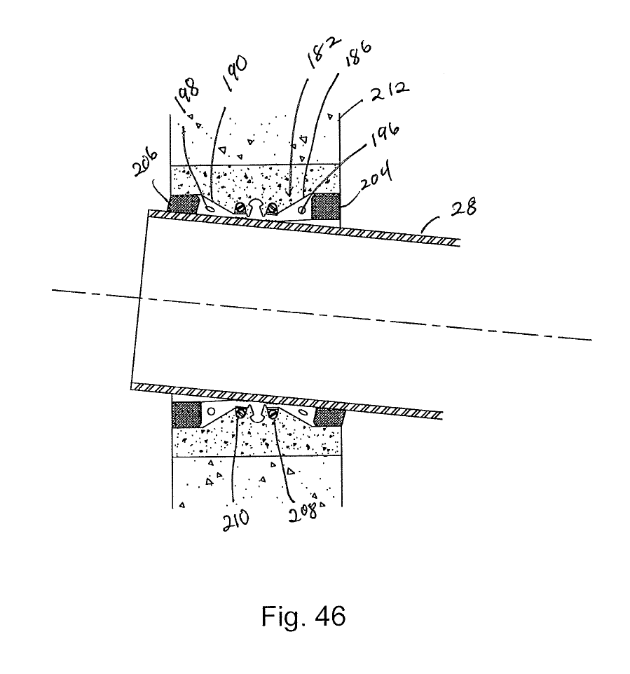

Another illustrative embodiment of the present disclosure includes a compression seal that wraps around the pipe directly as shown in FIGS. 29 through 50. In these embodiments, the compression seal is first fitted around the pipe and then either cast or mortared into the manhole. As shown in the embodiment in FIGS. 29 through 32, compression seal 132, similar to compression seal 112 shown in the prior embodiment, has a body 134 and primary and secondary lobes 136 and 140. Compression seal 132 also includes cavity groups 142 and 144 to further compress compression seal 132 if necessary. Circumferential clamps 146 and 148 fit onto band receipt areas 150 and 152, respectively, as shown in FIGS. 29 through 32. To assist keeping compression seal 132 at a desired location on pipe 28, an adhesive 154 is located there between, as also shown in FIG. 29.

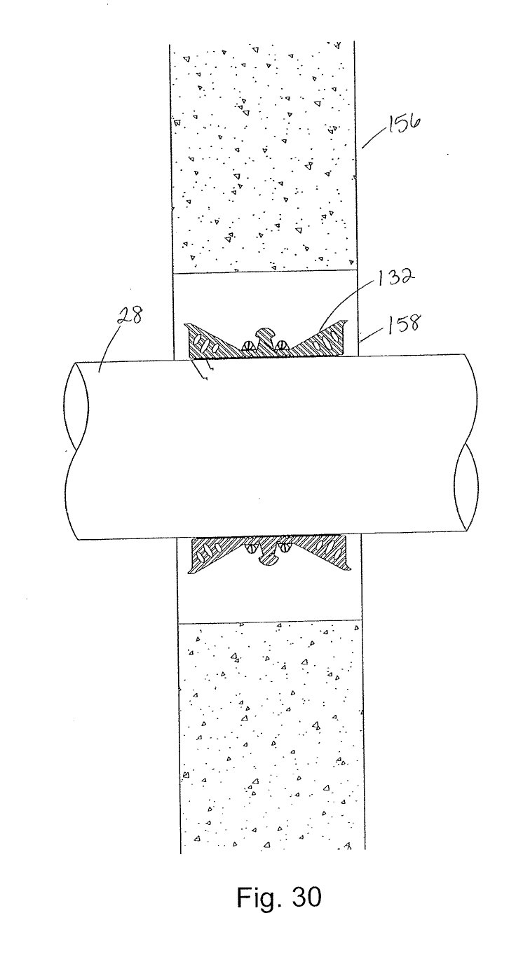

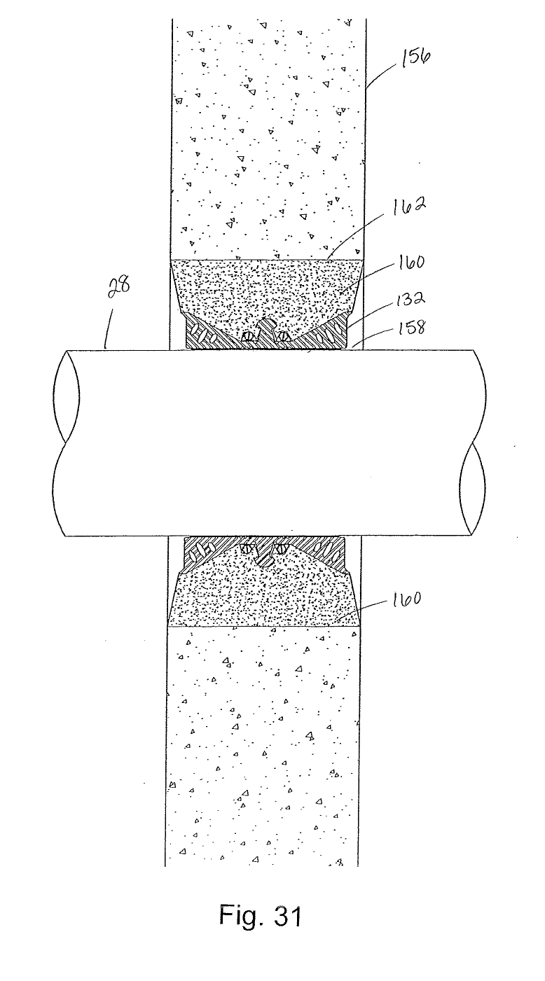

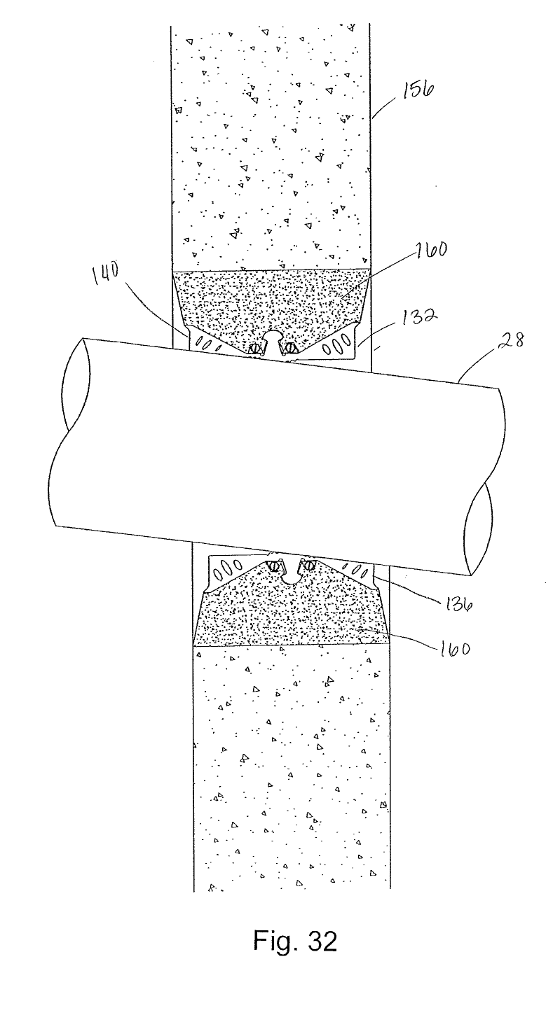

A side partial cross-sectional view of pipe 28 disposed through a manhole 156 is shown in FIG. 30. Specifically, pipe 28 is depicted having compression seal 132 wrapped thereabout and located in opening 158 of manhole 156. In this embodiment, manhole 156 may be a precast-type manhole that is already formed with opening 158 disposed therein. As shown in the similar view in FIG. 31, mortar 160 fills in between compression seal 132 and periphery 162 of opening 158 of manhole 156. By filling in the space as shown, an effective seal is created between the interior and exterior of manhole 156. The view in FIG. 32 is similar to the prior views in FIGS. 30 and 31, illustrating the sealing capability of compression seal 132. Illustratively as shown, pipe 28 in this view may be pivoted relative to manhole 156. Despite this deflection, it is demonstrated that a portion of compression seal 132, particularly lobes 136 and 140, help maintain a seal between the interior and exterior of manhole 156 despite movement of pipe 28.

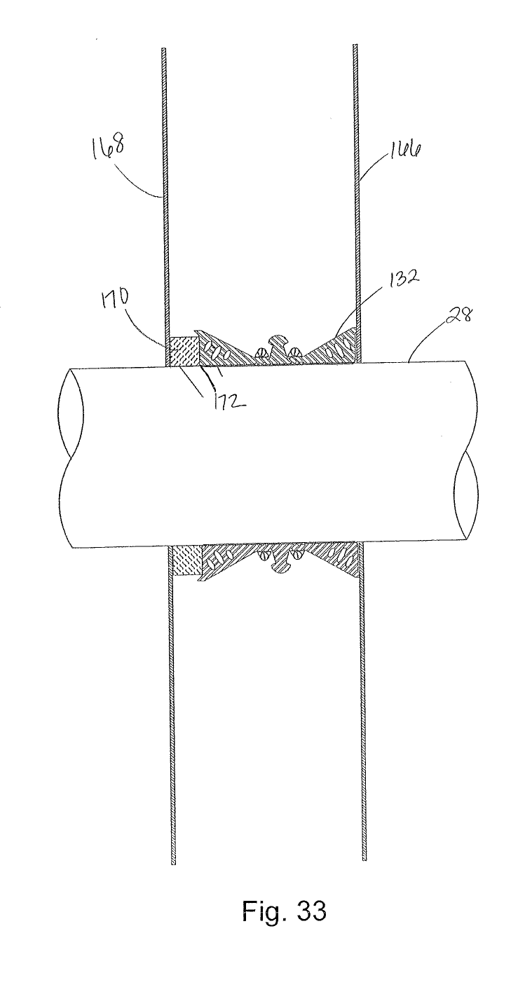

Side sectional views of FIGS. 33 through 36 depict a second manner of installing pipe 28 with a compression seal 132 shown in FIG. 29. In this additional embodiment, rather than a precast manhole, such as manhole 156 previously discussed, compression seal 132 wrapped around pipe 28 may be fitted within manhole forms 166 and 168 set to create a cast-in-type manhole. Shown in FIG. 33 are forms 166 and 168 set to create a new manhole along with removable, flexible filler material 170 that may be placed around the pipe 28 between compression seal 132 and either one of the forms (for example form 168 is shown here). An adhesive may be used to improve retention of the seal in its folded position. This adhesive may include a pre-applied tape with a removable protective barrier such as film 172 shown. Alternatively, a contact adhesive may be applied to the inner diameter of the compression seal after the casting mandrel is removed and prior to folding the compression seal. According for the embodiments described herein, it is appreciated that the adhesives may be applied to the compression seal either through pre-application of the adhesive with a protective barrier (removed after casting and prior to folding), or during the installation process using a contact adhesive. Larger diameter compression seals may realize more benefits of using the adhesive than smaller diameter compression seals in straight-wall applications.

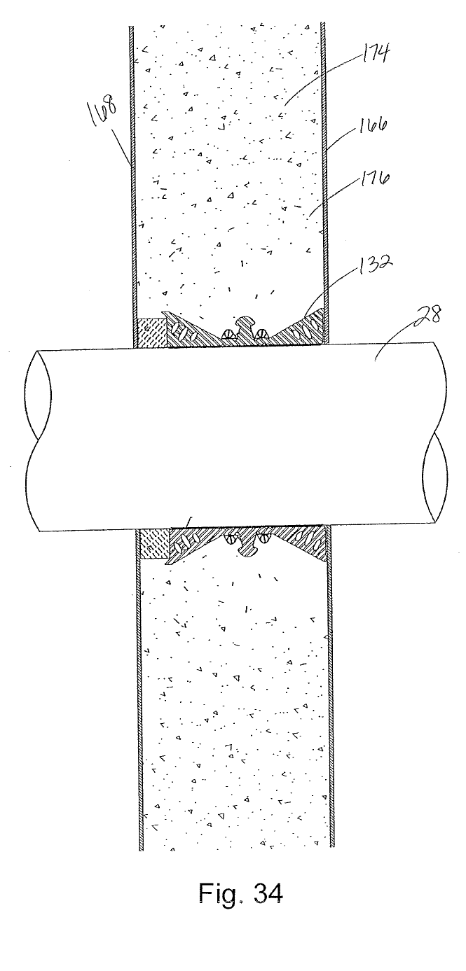

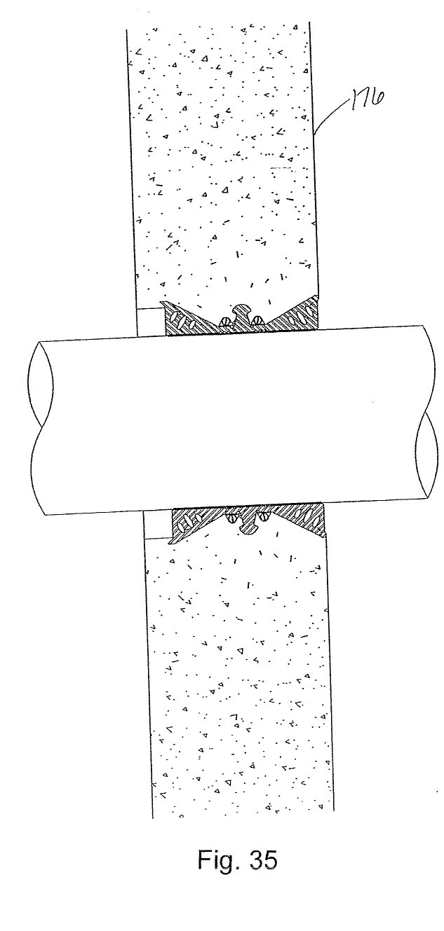

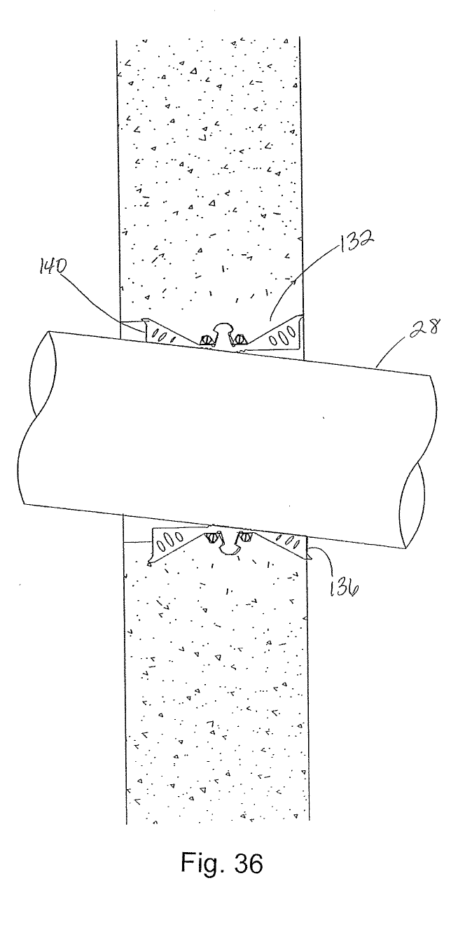

The view in FIG. 34 is similar to that of FIG. 33 except concrete 174 has been poured between forms 166 and 168 to form new manhole 176. As depicted, by filling between forms 166 and 168 with concrete 174 around compression seal 132 a seal may be created between same and pipe 28. The view in FIG. 35 is similar to that of FIGS. 33 and 34, but with forms 166 and 168 removed forming the finished manhole 176. Also removed is filler material 170. The view shown in FIG. 36 is similar to FIG. 32 of the prior embodiment where pipe 28 is deflected with respect to compression seal 132 demonstrating how a seal may still be maintained via lobes 136 and 140.

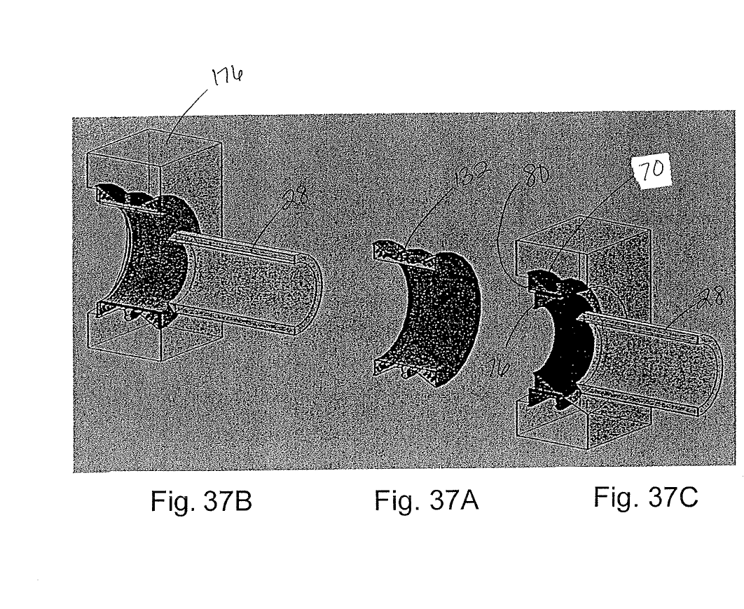

FIGS. 37A through 37C show side perspective cross-sectional views of compression seal 132 in isolation and then in manhole 176 with pipe 28 removed therefrom. The view in FIG. 37C shows compression seal 70 with lobe 76 folded under lobe 80 in manhole 98 as discussed in prior embodiments.

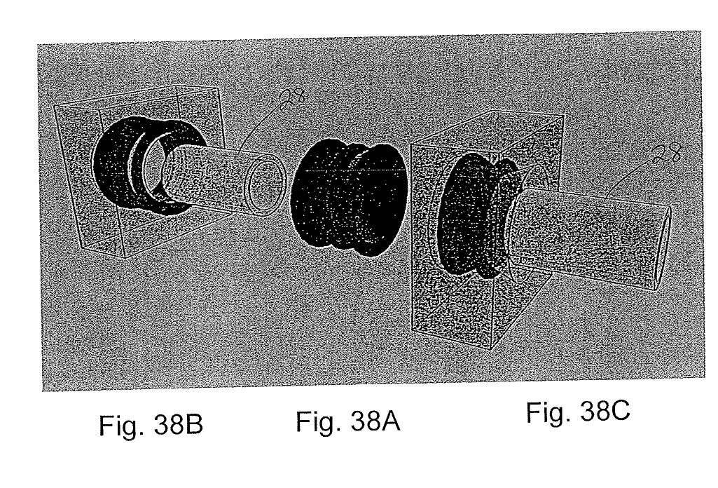

Also, similar to the views shown in FIGS. 37A through 37C, are the views shown in FIGS. 38A through 38C depicting ghost views of the same structures with pipe 28 removed demonstrating how it may be inserted into the openings of the compression seal.

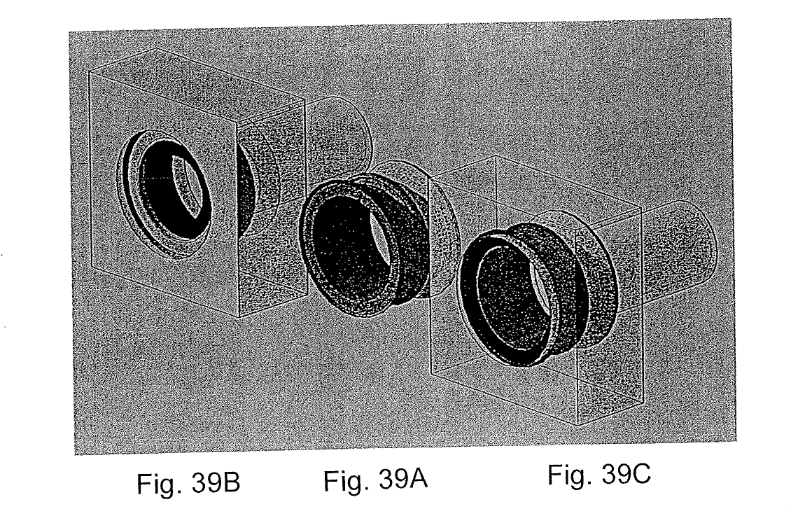

The views in FIGS. 39A through 39C are similar ghost views of the manhole, but showing a reversed angle to further depict how pipe 28 is inserted into the compression seals.

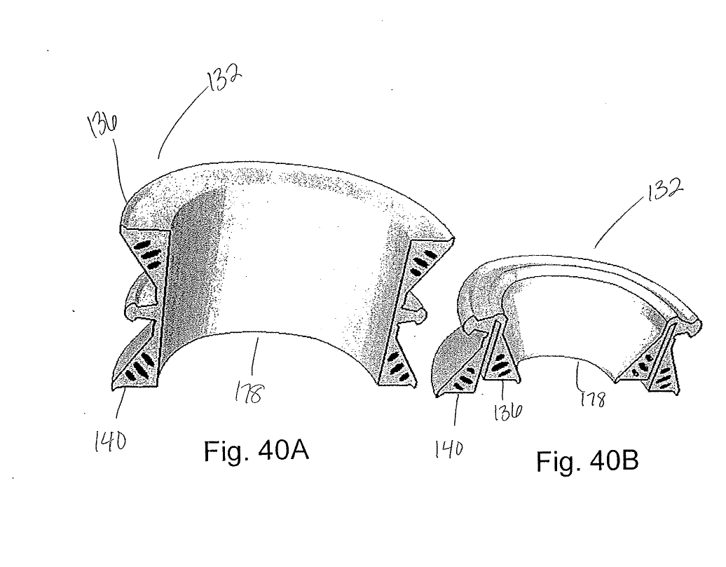

Side cross-sectional perspective views of compression seal 132 in folded and unfolded forms are shown in FIGS. 40A and 40B, respectively. The view of compression seal 132 in FIG. 40B depicts lobe 136 folded over with respect to lobe 40 as explained with regard to prior embodiments. This view further demonstrates how an opening 178 is narrowed when compared to opening 178 in FIG. 40A.

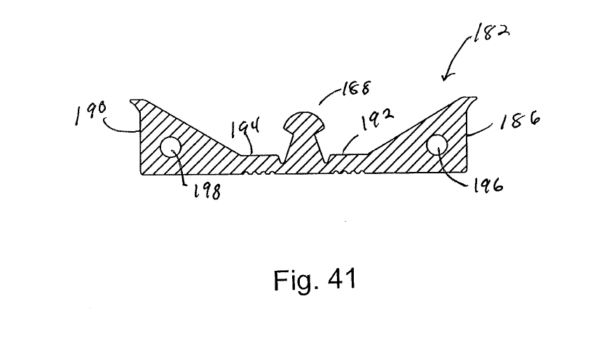

Another illustrative embodiment of a compression seal 182 may also embody characteristics and functions of prior embodiments. As shown in the cross-sectional view in FIG. 41, compression seal 182 includes a body 184, as well as lobes 186 and 190. An anchoring lobe 188 is located between lobes 186 and 190 similar to the prior embodiments. Clamp areas 192 and 194 are located between the lobes 186, 190 and anchoring lobe 188 as shown. Lastly, compression cavities 196 and 198 are disposed in each lobe 186 and 190, respectively.

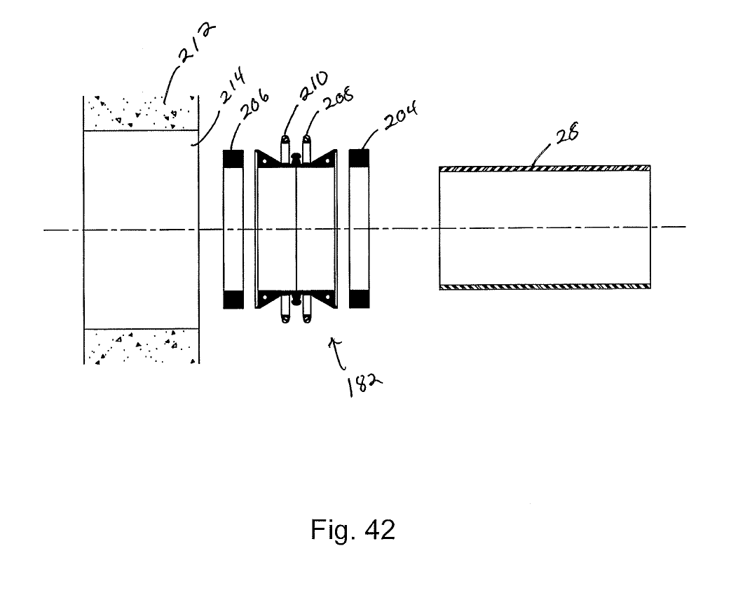

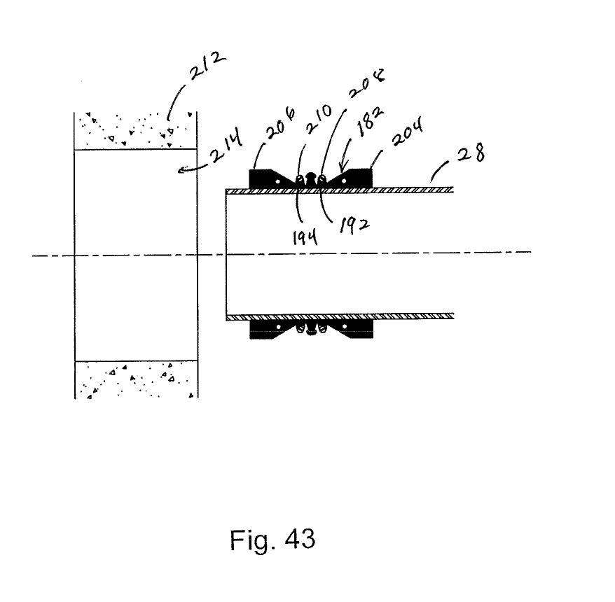

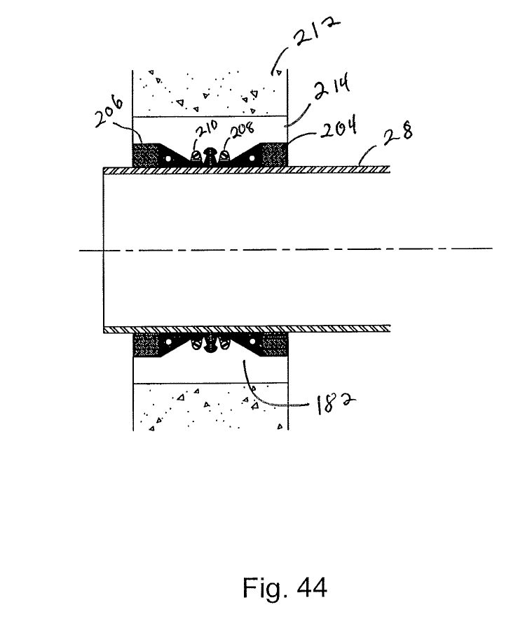

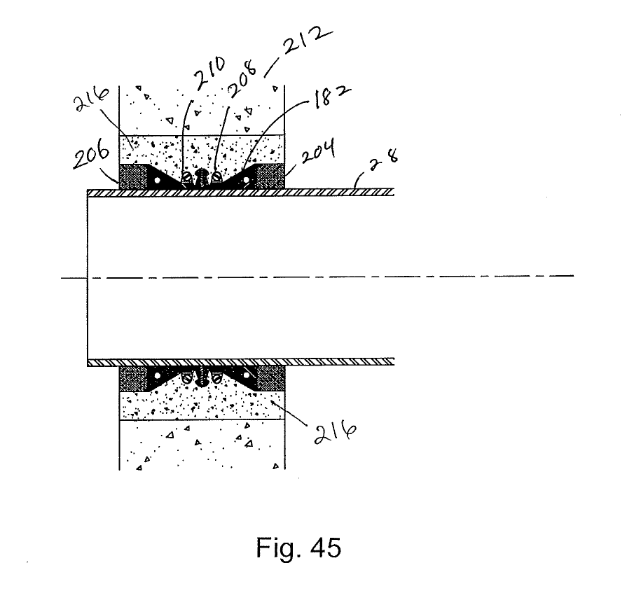

An exploded view of components employed for installing the compression seal in a manhole, similar to those discussed in the previous embodiment, are shown in FIG. 42. Here, pipe 48, along with filler seals 204 and 206, flank resilient seal 182. Additionally, bands 208 and 210 are shown being used as well. A distinction from some of the prior embodiments is that here a manhole 212 with an opening 214 disposed therein has already been cast. In the similar view shown in FIG. 43, compression seal 182 flanked by filler material 204 and 206 is fitted about pipe 28. Clamps 208 and 210 secure seal 182 to pipe 28 at clamp areas 192 and 194, respectively. As depicted, compression seal 182 becomes part of an assembly that secures onto pipe 28 before it is inserted into opening 214 of manhole 212. With this accomplished, however, it becomes convenient when in the field to connect all these components with manhole 212 by simply inserting them into opening 214, as shown in FIG. 44. All that is left is for mortar 216 to fill opening 214 of manhole 212 around compression seal 182 and its associated structures as shown in FIG. 45. It is appreciated from this view how adding the mortar 216 to fill opening 214 when combined with compression seal 182 creates a seal between each side of manhole 212. And as discussed previously with respect to the other mortared-in embodiments, pipe 28 is free to deflect at non-perpendicular angles to manhole 212 while lobes 186 and 190 on compression seal 182 maintain a sealing contact.

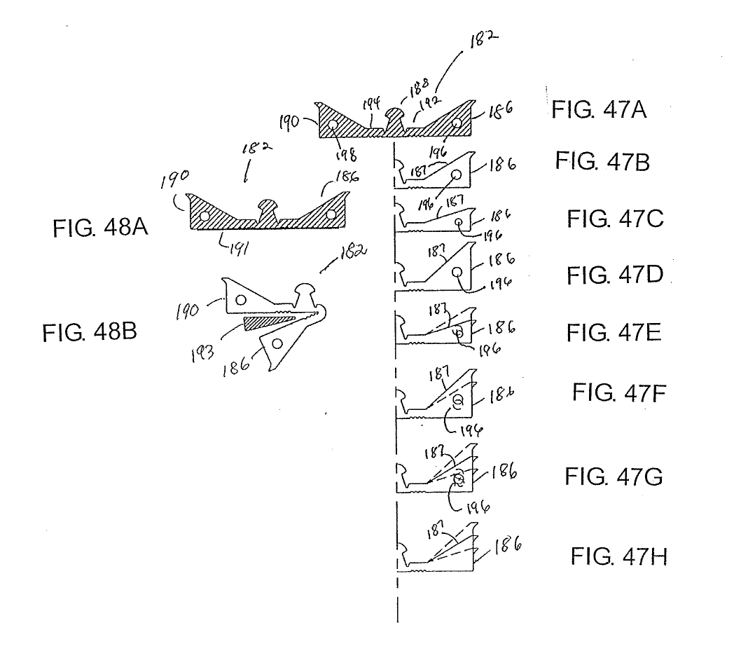

Side cross-sectional detail views of the primary lobe of compression seal 182 and its varying illustrative configurations are shown in FIGS. 47A through 47H. Particularly, the views depict how the angular deflection of lobe 186 may be changed. For example, FIGS. 47A and 47B show primary lobe 186 having a standard profile as shown in FIGS. 41 through 46. The angular deflection of surface 187 of lobe 186 may be reduced as shown in FIG. 47C or increased as shown in FIG. 47D. FIGS. 47E through 47H are detail overlay views depicting the relative deflection between the standard, increased, and decreased lobes. For example, FIG. 47E shows the relative angular difference between the standard profile (dashed lines) and the reduced deflection (overlay) of surface 187 of lobe 186. In contrast, FIG. 47F shows the difference between the standard profile (dashed lines) and the increased deflection (overlay) of surface 187. FIGS. 47G and 47H show both the increased and reduced angular deflected versions overlaid on the standard profile. Additionally, cavity 196 is shown in lobe 186 of FIG. 47G but removed in FIG. 47G. Like the prior embodiments, FIG. 48A shows adhesive layer 191 being applied to the undersurface of compression seal 182. In addition, wedge 193, as shown in FIG. 48B, may be employed with compression seal 182 in the same manner described in prior embodiments.

For clarity, it is appreciated that both the prior embodiments of the compression seal—a compression seal that employs band clamps, and a compression seal that does not—may be used in a manhole such as a sanitary manhole that may be itself cylindrical. In those instances, the openings such as openings 30 and 100 from the prior embodiments are not only circular in one direction, but also cylindrical in two directions.

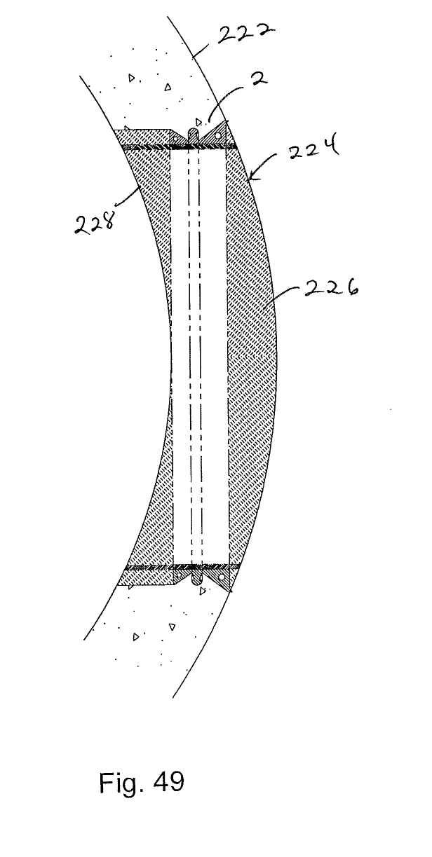

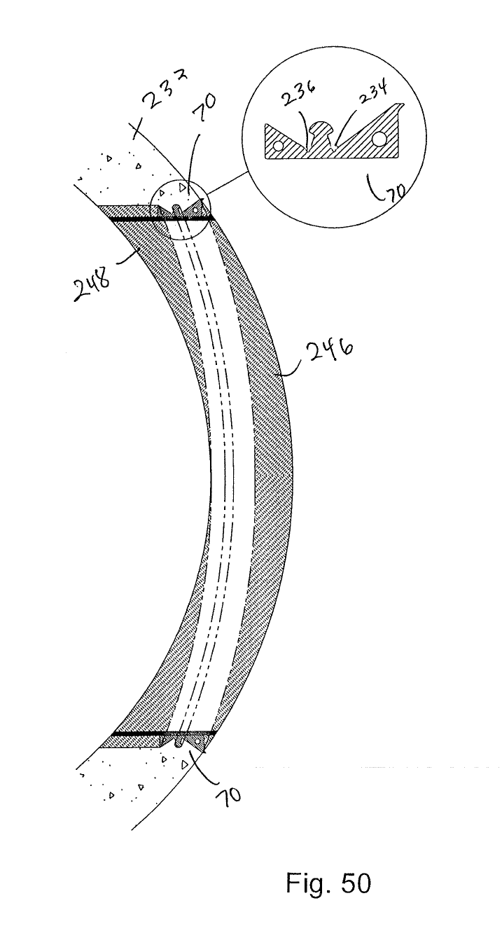

Top sectional detail views of manholes 222 and 232 in FIGS. 49 and 50, respectively, are views looking downward into the manholes 222 and 232, respectively. In FIG. 49, manhole 222 includes an opening 224 that may employ a resilient seal such as seal 2. In instances where the manhole is round, resilient filler material 226 and 228 may be inserted on each side of compression seal 2 in order to conform between the forms of the walls of the manhole and compression seal 2. In the embodiments shown, compression seal 2 may be placed linearly with respect to the curve wall as shown in FIG. 49. In contrast, however, a compression seal such as 70 may employ retention bands 234 and 236 to hold compression seal 70 in a curved plane as shown in FIG. 50. Similar to the resilient material 226 and 228 shown in FIG. 49, resilient material 246 and 248 may also conform to the desired curved shape as shown in FIG. 50 to allow casting of the manhole in the shape shown. Resilient seal 70 in this instance is retained by bands that are not only circular in one claim, but also curved in a perpendicular claim as shown in FIG. 50. This allows flexible and adaptive use of the compression seals in both square and cylindrical-type manholes.

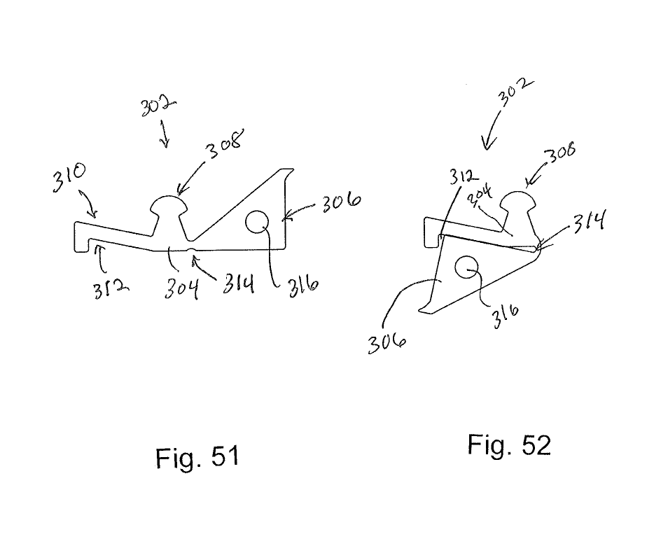

Another illustrative embodiment of the present disclosure provides a resilient seal 302 that comprises a body 304, a lobe 306 an anchoring lobe 308, and secondary lobe 310 is shown in FIG. 51. This embodiment is distinguishable from the previous embodiments in that secondary lobe 310 requires substantially less material to form than having a full lobe such as primary lobe 306. Additionally, secondary lobe includes a folding cavity 312 on its underside, as well as a hinged portion 314 between anchoring lobe 308 and lobe 306 on the underside of compression seal 302. Hinge 314 is illustratively made of the same material and can be molded as part of body 304, but is characterized by an indentation or reduction in material at the hinge location to potentially reduce retaining stress during folding. Also shown in this view is cavity 316 to provide space that portions of lobe 306 may collapse into during use.

It is appreciated that aside from the distinctive profile of compression seal 302 of the previous embodiments, compression seal 302 shown is a cylindrical body made of rubber or like resilient material useful for sealing purposes and having a lobe that folds over to reduce the inner diameter of the compression seal to provide sealing capabilities between a pipe and manhole. As shown in the cross-sectional view of FIG. 52, compression seal 302 is depicted with lobe 306 folded at hinge 314 with a portion of lobe 306 fitted in cavity 312. It is appreciated from this view that folding lobe 306 in cavity 312 is a beyond 180 degree, or an over-center-fold. This, when combined with the reduction in hinge thickness at 314, is believed to reduce the retained stress at the hinge and produce a more secure fold.

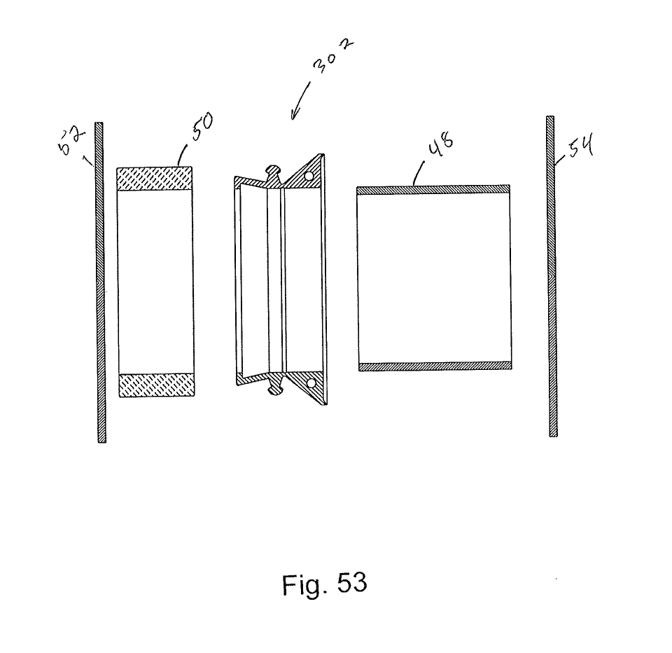

The view in FIG. 53 is similar to that in FIGS. 4 and 14 among others, demonstrating how compression cylinder 302 may be used in a manhole system similar to those previously discussed. As shown in FIG. 53, compression seal 302 may be employed with mandrel 48 and form walls 52 and 54 in the same manner as discussed with the prior embodiments. In addition, resilient material 50 may be used as well as previously described.

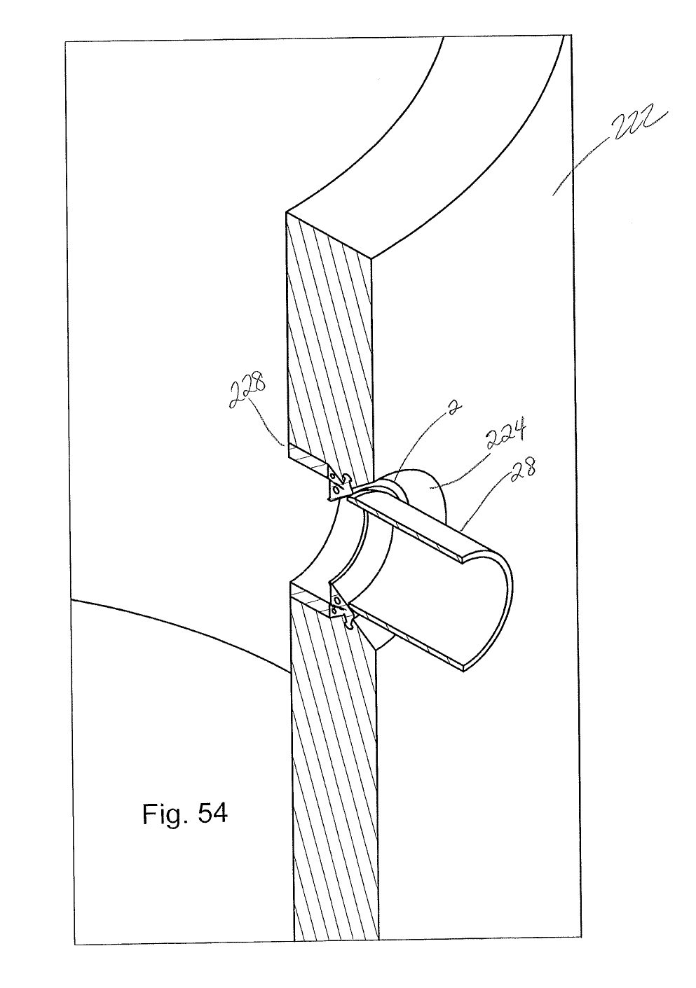

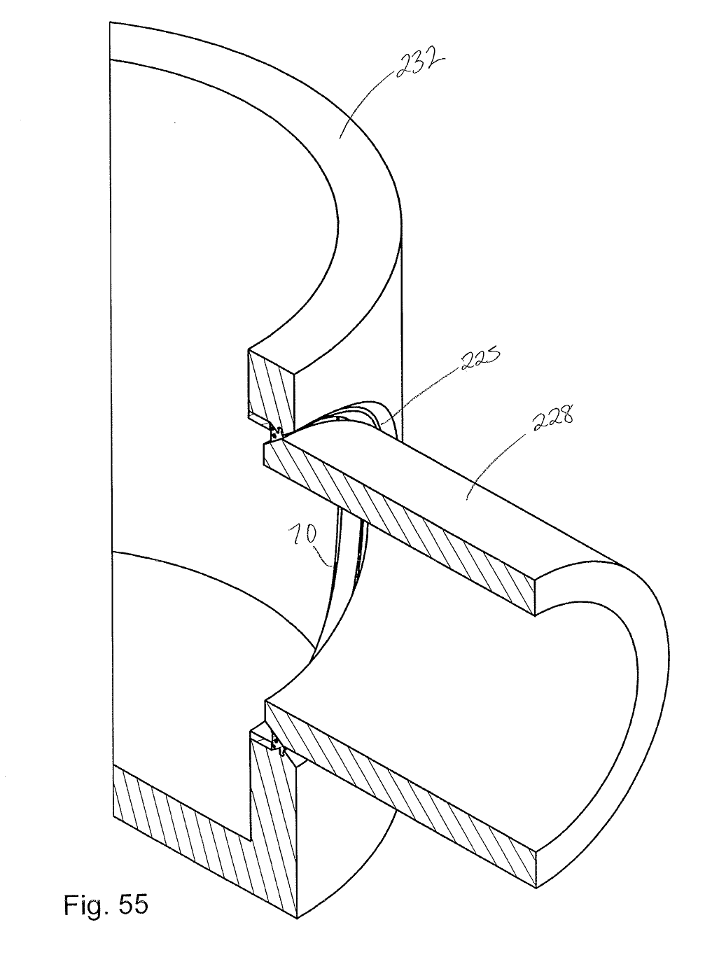

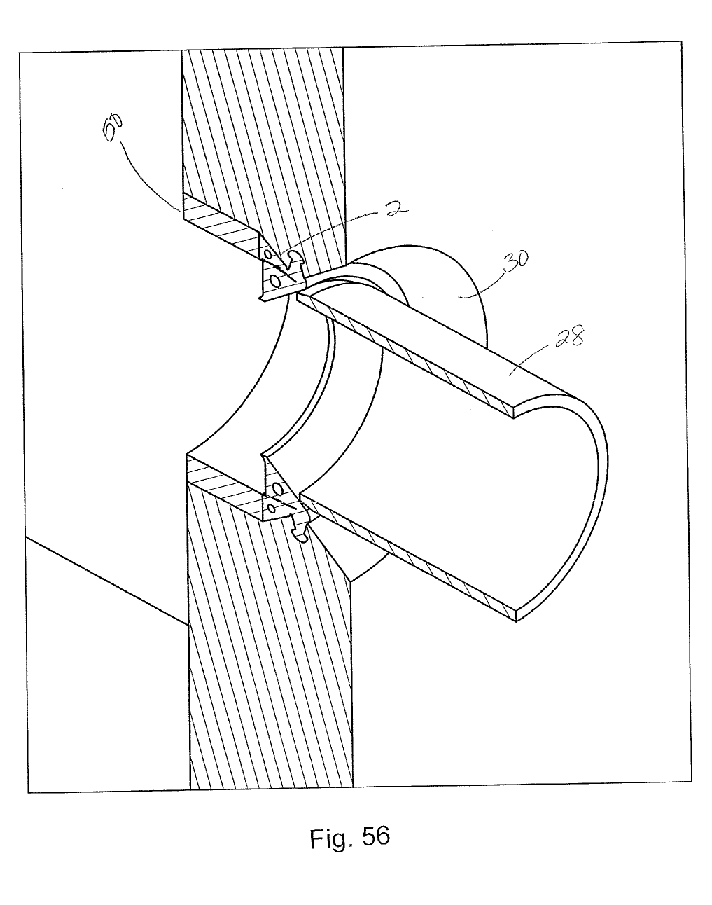

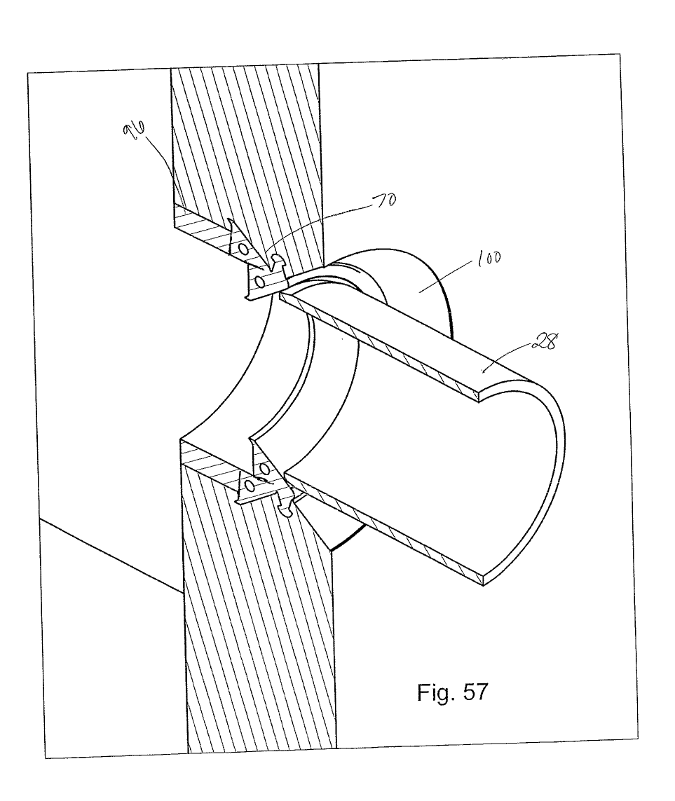

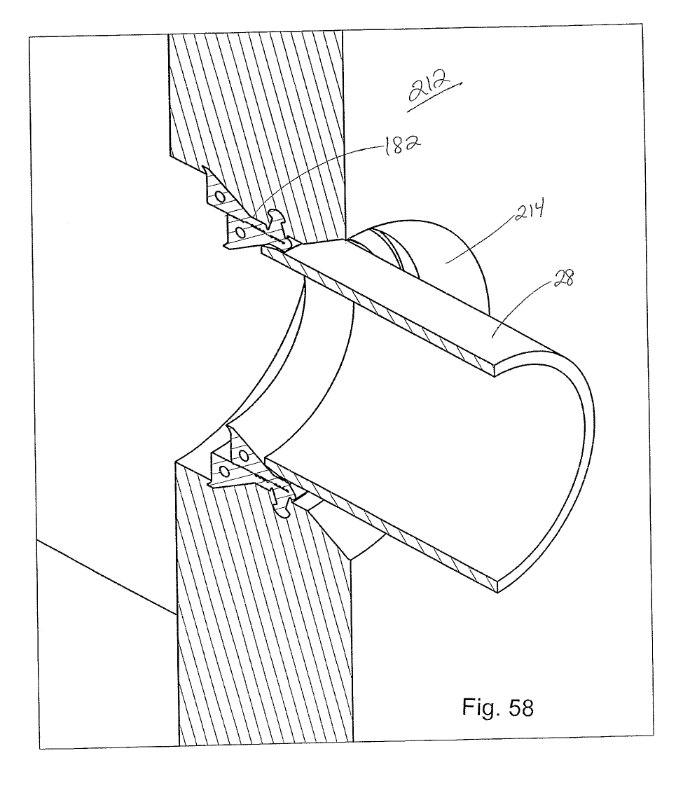

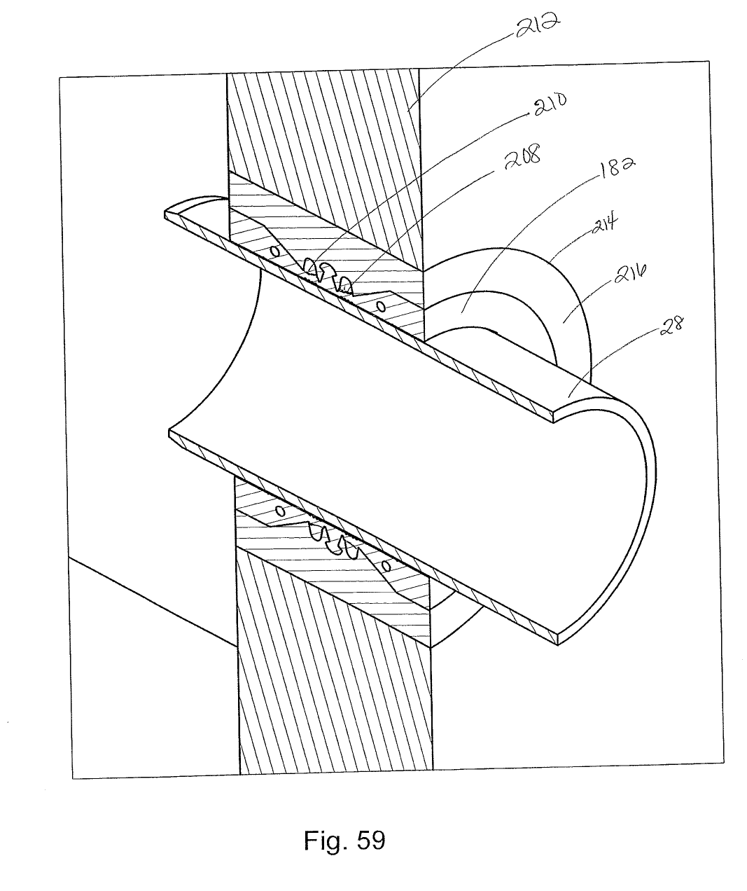

Perspective cross-sectional detail views of a manhole or other like structure is shown in FIGS. 54 through 59 depicting a pipe set to be inserted into an opening of the structure. Particularly, in FIGS. 54 and 55, the manhole has a cylindrical body such as manhole 222 shown in FIG. 49. Also similar to that view is opening 224, compression seal 2 disposed therein, and pipe 28 set to be disposed through opening 224. Filler material 228 is shown abutting against compression seal 2 located in its folded position. Similarly in FIG. 55, cylindrical manhole 232 is set to receive pipe 228 shown to be engaged in compression seal 70. In this embodiment, opening 225 receives compression seal 70 such that it not only encircles opening 70 but is also curved along the cylindrical shape of manhole 232 as shown therein. (See also FIG. 50). The views in FIGS. 56 through 58 further depict how compression seals 2, 70, and 182 may be folded over inside the opening of the manhole to receive pipe 28. The view in FIG. 59 is similar to that of FIG. 45 but in cross-sectional perspective view depicting compression seal 182 fitted on to pipe 28, held in place with bands 208 and 210 in manhole 212. Opening 214 is filled with mortar 216 to fill in the gap between the periphery of opening 214 and compression seal 182.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A compression seal configured to be disposed about a pipe, the compression seal comprising:
a cylindrical body made of a resilient material;
wherein the cylindrical body includes a hollow bore extending a longitudinal extent of the cylindrical body;
wherein the cylindrical body includes an outer surface and an inner cylindrical surface;
wherein the inner cylindrical surface faces and defines the hollow bore, and the outer surface is located on the cylindrical body opposite the inner cylindrical surface;
wherein the cylindrical body comprises a primary lobe, a secondary lobe, and an anchoring lobe located between primary and secondary lobes;
wherein the primary and secondary lobes and the anchoring lobe extend longitudinally as at least part of the outer surface of the cylindrical body and substantially tangential to the longitudinal extent of the cylindrical body;
wherein the primary lobe has an inclined plane surface;
wherein the inclined plane surface of the primary lobe ascends in a direction away from the anchoring lobe;
a bendable portion of the cylindrical body between the anchoring lobe and the primarily lobe; and
wherein the primary lobe is foldable with respect to the cylindrical body at the bendable portion in a direction toward the hollow bore, the inner cylindrical surface and the secondary lobe.

2. The compression seal of claim 1 wherein the primary lobe is bendable into the hollow bore to form a conically shaped opening that reduces the diameter of the hollow bore to provide additional compressive material during engagement with the pipe.

3. The compression seal of claim 1 wherein the secondary lobe includes a protrusion depending from the inner cylindrical surface of the cylindrical body; and wherein the protrusion is configured to engage a portion of the primary flange when folded into the hollow bore of the cylindrical body.

4. The compression seal of claim 1 wherein the cylindrical body is made of rubber.

5. The compression seal of claim 1 wherein the primary lobe includes at least one cavity that is deformable under pressure.

6. The compression seal of claim 1 wherein the cylindrical body is configured to receive a retaining band between the anchoring lobe and the primary lobe; and wherein the retaining band is configured to encircle the compression seal.

7. The compression seal of claim 1, wherein the secondary lobe has an inclined plane surface that ascends in a direction away from the anchoring lobe;

8. The compression seal of claim 1, wherein the cylindrical body includes an adhesive on the inner cylindrical surface that is engagable with the primary lobe.

9. The compression seal of claim 2, further comprising a wedge structure that is selectively engagable to both the inner cylindrical surface of the cylindrical body and the primary lobe bent into the hollow bore to form a conically shaped opening that reduces the diameter of the hollow bore to a greater extent than when not using the wedge.

10. The compression seal of claim 1, wherein the inner cylindrical surface further includes a notch located adjacent the primary lobe and the anchoring lobe.

11. A compression seal configured to be disposed about a pipe, the compression seal comprising:
a cylindrical body made of a resilient material;
wherein the cylindrical body includes a hollow bore extending a longitudinal extent of the cylindrical body;
wherein the cylindrical body includes an outer surface and an inner cylindrical surface;
wherein the inner cylindrical surface faces and defines the hollow bore, and the outer surface is located on the cylindrical body opposite the inner cylindrical surface;
wherein the cylindrical body comprises a primary lobe and a secondary lobe;
wherein the primary and secondary lobes extend longitudinally as at least part of the outer surface of the cylindrical body;
wherein the primary lobe has an inclined plane surface; and
wherein the inclined plane surface of the primary lobe ascends in a direction away from the secondary lobe.

12. The compression seal of claim 11, wherein the secondary lobe includes an inclined plane surface that ascends in a direction away from the primary lobe.

13. The compression seal of claim 12, wherein the hollow bore of the cylindrical body is configured to receive a pipe; wherein the inner cylindrical surface is located opposite the primary and secondary lobes; and wherein primary and secondary lobes are configured to be supported by the pipe extended through the hollow bore.

14. The compression seal of claim 11, further comprising a bendable portion of the cylindrical body adjacent the primary lobe.

15. The compression seal of claim 14, wherein the primary lobe is foldable with respect to the cylindrical body at the bendable portion in a direction toward the hollow bore, the inner cylindrical surface and the secondary lobe.

16. The compression seal of claim 15, wherein the primary lobe is bendable into the hollow bore to form a conically shaped opening that reduces the diameter of the hollow bore to provide additional compressive material during engagement with the pipe.

17. The compression seal of claim 11, wherein the secondary lobe includes a protrusion depending from the inner cylindrical surface of the cylindrical body; and wherein the protrusion is configured to engage a portion of the primary flange when folded into the hollow bore of the cylindrical body.

18. The compression seal of claim 11, wherein the primary lobe includes at least one cavity that is deformable under pressure.

19. A method for installing a pipe in a manhole, the method comprising the steps of:
providing a compression seal that includes a cylindrical body made of a resilient material, wherein the cylindrical body includes a hollow bore extending a longitudinal extent of the cylindrical body; wherein the cylindrical body includes an outer surface and an inner cylindrical surface, wherein the inner cylindrical surface faces and defines the hollow bore and the outer surface is located on the cylindrical body opposite the inner cylindrical surface, wherein the cylindrical body comprises a primary lobe and a secondary lobe located opposite the secondary lobes, wherein the primary and secondary lobes extend longitudinally as at least part of the outer surface of the cylindrical body and substantially tangential to the longitudinal extent of the cylindrical body, wherein the primary lobe has an inclined plane surface, wherein the inclined plane surface of the primary lobe ascends in a direction away from the secondary lobe, and a bendable portion of the cylindrical body adjacent the primarily lobe;
providing also a casting mandrel and inner and outer form walls;
placing the inner form wall spaced apart and facing the outer form wall to create at least a portion of a manhole shape;
disposing the casting mandrel through the hollow bore of the compression seal;
placing the casting mandrel and compression seal between the inner and outer form walls;
filling space between the form walls and around the compression seal with concrete such that the concrete forms at least a portion of the manhole;
removing the inner and outer form walls and the mandrel from the concrete after the concrete has solidified, wherein the removing of the casting mandrel leaves an opening in the manhole with the inner cylindrical surface of the compression seal forming a periphery of the opening of the manhole; and
folding the primary lobe of the compression seal at the bendable portion over in the opening of the manhole toward the secondary lobe of the compression seal reducing the opening's diameter when the primary lobe is folded over toward the secondary lobe.

20. The method for installing the pipe in the manhole of claim 19, further comprising the steps of inserting a pipe into the opening of the manhole engaging a seal between the pipe and the primary lobe of the compression seal.
